(19) United States
(12) Patent Application Publication
(10) Pub. No.: US 2007/0045893 A1
(43) Pub. Date: Mar. 1, 2007

(54) Multilayer thermoplastic films and methods of making

(76) Inventors: Himanshu Asthana, Evansville, IN (US); Aniruddha Moitra, Bangalore (IN); David Rosendale, Mt. Vernon, IN (US)

Correspondence Address: CANTOR COLBURN, LLP, 55 GRIFFIN ROAD SOUTH, BLOOMFIELD, CT, 06002, US

(21) Appl. No.: 11/213,580

(22) Filed: Aug. 26, 2005

(51) Int. Cl. B29C 47/06

(52) U.S. Cl. 264/173.12; 156/244.11; 264/173.16; 264/173.18

(57) ABSTRACT

A method of forming a multilayer film is disclosed, comprising coextruding a first layer comprising a weatherable composition, and a second layer comprising a polycarbonate composition comprising a visual effect filler, wherein the first and second layers are formed by flowing each of the weatherable composition and polycarbonate composition through separate flow channels in a multi-manifold coextrusion die. The shear stress during extrusion on the polycarbonate composition is greater than or equal to 40 kilo-Pascals.

### BACKGROUND

This disclosure relates to multilayer films comprising polycarbonates, and methods of making same.

Polycarbonates are useful in a broad spectrum of applications because of their high gloss, optical clarity, excellent color capability, mechanical properties including impact strength, and melt flow properties. Multilayer films comprising polycarbonate compositions can further be designed to have a combination of properties including weatherability, scratch resistance, and optical clarity, and can support surface finish properties such as gloss or matte finishes, color, and metallic effects suitable for use in a paint replacement layer. A multilayer film having these properties is bonded to the exterior of an article before or during molding to a desired shape to form the article. Articles formed in this way, having multilayer film as a paint replacement layer, include automotive exterior panels, trunk lids, bumpers, and the like.

Coextrusion to form multilayer films is an advantageous method of manufacture, having a lower cost of inventory and handling for multilayer films so produced. Thin (less than 200 mil, or 5,080 micrometer) multilayer films prepared using coextrusion methods can exhibit a defective appearance however, where an optically visual effect filler to provide a metallic finish is dispersed in one or more of the layers. Parallel line defects, alternatively referred to as “streaks” manifesting as parallel lines coincident with the direction of extrusion, have been observed in such multilayer films. Streaks diminish the usefulness of these multilayer films for applications in which a high quality visual appearance is desired, by presenting a non-uniform, variable color and/or metallic finish.

Accordingly, there remains a need in the art for a method of manufacturing multilayer films with improved visual appearance.

### SUMMARY OF THE INVENTION

Disclosed herein is a method of forming a multilayer film, comprising coextruding a first layer comprising a first polycarbonate composition, with a second layer comprising a second polycarbonate composition comprising a polycarbonate and a visual effects filler, wherein the second polycarbonate composition is subject to a shear stress of greater than or equal to 40 kilo-Pascals during the coextruding.

The above described and other features are exemplified by the following figures and detailed description.

### BRIEF DESCRIPTION OF THE DRAWINGS

We refer now to the figures, which are meant to be exemplary, not limiting.

FIG. 1 is a diagram of a multilayer coextrusion die in cross section, along the direction of flow.

FIG. 2 is a cross-sectional view of an embodiment of a multilayer film.

FIG. 3 is a cross-sectional view of another embodiment of a multilayer film.

FIG. 4 is a transmission electron micrograph of a portion of a multilayer film with streaks.

FIG. 5 is a transmission electron micrograph of a portion of a multilayer film without streaks.

### DETAILED DESCRIPTION

Surprisingly, it has been found that extrusion of a polycarbonate composition comprising a polycarbonate and visual effect filler (i.e., a filler having light-reflecting and/or light refracting properties) above a suitable shear stress value provides a layer of a multilayer film without parallel line defects (i.e., streaks). As used herein, “without” means free of visually observable streaks, as determined using the naked eye at a suitable distance. In an embodiment, a suitable shear stress during extrusion is greater than or equal to 40 kilo-Pascals (kPa). As used herein, the shear stress, reported in kilo-Pascals (kPa), is the stress exerted on the polycarbonate composition as it is extruded through the narrowest dimension of a flow channel in an extrusion die. The shear stress vector is normal to the direction of flow.

The layers in the multilayer film comprise polycarbonate. As used herein, the term “polycarbonate” and “polycarbonate resin” means compositions having repeating structural carbonate units of the formula (1): 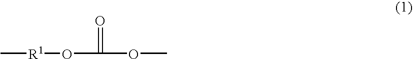
in which greater than or equal to about 60 percent of the total number of R¹ groups are aromatic organic radicals and the balance thereof are aliphatic, alicyclic, or aromatic radicals. In one embodiment, each R¹ is an aromatic organic radical, for example a radical of the formula (2):
—A¹—Y¹—A²— (2)

wherein each of A¹ and A² is a monocyclic divalent aryl radical and Y¹ is a bridging radical having one or two atoms that separate A¹ from A². In an exemplary embodiment, one atom separates A¹ from A². Illustrative non-limiting examples of radicals of this type are —O—, —S—, —S(O)—, —S(O₂)—, —C(O)—, methylene, cyclohexyl-methylene, 2-[2.2.1]-bicycloheptylidene, ethylidene, isopropylidene, neopentylidene, cyclohexylidene, cyclopentadecylidene, cyclododecylidene, and adamantylidene. The bridging radical Y¹ can be a hydrocarbon group or a saturated hydrocarbon group such as methylene, cyclohexylidene, or isopropylidene.

Polycarbonates can be produced by the interfacial reaction of dihydroxy compounds having the formula HO—R¹—OH, which includes dihydroxy compounds of formula (3):
HO—A¹—Y¹—A²—OH (3)
wherein Y¹, A¹ and A² are as described above. Also included are bisphenol compounds of general formula (4): 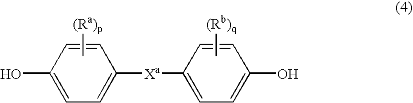
wherein R^{a} and R^{b} each represent a halogen atom or a monovalent hydrocarbon group and can be the same or different; p and q are each independently integers of 0 to 4; and X^{a} represents one of the groups of formula (5): 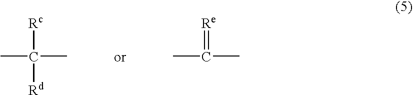
wherein R^{c} and R^{d} each independently represent a hydrogen atom or a monovalent linear or cyclic hydrocarbon group and R^{e} is a divalent hydrocarbon group.

Some illustrative, non-limiting examples of suitable dihydroxy compounds include the following: resorcinol, 4-bromoresorcinol, hydroquinone, 4,4′-dihydroxybiphenyl, 1,6-dihydroxynaphthalene, 2,6-dihydroxynaphthalene, bis(4-hydroxyphenyl)methane, bis(4-hydroxyphenyl)diphenylmethane, bis(4-hydroxyphenyl)-1-naphthylmethane, 1,2-bis(4-hydroxyphenyl)ethane, 1,1-bis(4-hydroxyphenyl)- 1-phenylethane, 2-(4-hydroxyphenyl)-2-(3-hydroxyphenyl)propane, bis(4-hydroxyphenyl)phenylmethane, 2,2-bis(4-hydroxy-3-bromophenyl)propane, 1,1-bis (hydroxyphenyl)cyclopentane, 1,1-bis(4-hydroxyphenyl)cyclohexane, 1,1-bis(4-hydroxyphenyl)isobutene, 1,1-bis(4-hydroxyphenyl)cyclododecane, trans-2,3-bis(4-hydroxyphenyl)-2-butene, 2,2-bis(4-hydroxyphenyl)adamantine, (alpha, alpha′-bis(4-hydroxyphenyl)toluene, bis(4-hydroxyphenyl)acetonitrile, 2,2-bis(3-methyl-4-hydroxyphenyl)propane, 2,2-bis(3-ethyl-4-hydroxyphenyl)propane, 2,2-bis(3-n-propyl-4-hydroxyphenyl)propane, 2,2-bis(3-isopropyl-4-hydroxyphenyl)propane, 2,2-bis(3-sec-butyl-4-hydroxyphenyl)propane, 2,2-bis(3-t-butyl-4-hydroxyphenyl)propane, 2,2-bis(3-cyclohexyl-4-hydroxyphenyl)propane, 2,2-bis(3-allyl-4-hydroxyphenyl)propane, 2,2-bis(3-methoxy-4-hydroxyphenyl)propane, 2,2-bis(4-hydroxyphenyl)hexafluoropropane, 1,1-dichloro-2,2-bis(4-hydroxyphenyl)ethylene, 1,1-dibromo-2,2-bis(4-hydroxyphenyl)ethylene, 1,1-dichloro-2,2-bis(5-phenoxy-4-hydroxyphenyl)ethylene, 4,4′-dihydroxybenzophenone, 3,3-bis(4-hydroxyphenyl)-2-butanone, 1,6-bis(4-hydroxyphenyl)-1,6-hexanedione, ethylene glycol bis(4-hydroxyphenyl)ether, bis(4-hydroxyphenyl)ether, bis(4-hydroxyphenyl)sulfide, bis(4-hydroxyphenyl)sulfoxide, bis(4-hydroxyphenyl)sulfone, 9,9-bis(4-hydroxyphenyl)fluorine, 2,7-dihydroxypyrene, 6,6′-dihydroxy-3,3,3′,3′- tetramethylspiro(bis)indane (“spirobiindane bisphenol”), 3,3-bis(4-hydroxyphenyl)phthalide, 2,6-dihydroxydibenzo-p-dioxin, 2,6-dihydroxythianthrene, 2,7-dihydroxyphenoxathin, 2,7-dihydroxy-9,10-dimethylphenazine, 3,6-dihydroxydibenzofuran, 3,6-dihydroxydibenzothiophene, and 2,7-dihydroxycarbazole, and the like, as well as combinations comprising at least one of the foregoing dihydroxy compounds.

Specific examples of the types of bisphenol compounds that can be represented by formula (3) include 1,1-bis(4-hydroxyphenyl) methane, 1,1-bis(4-hydroxyphenyl) ethane, 2,2-bis(4-hydroxyphenyl) propane (hereinafter “bisphenol A” or “BPA”), 2,2-bis(4-hydroxyphenyl) butane, 2,2-bis(4-hydroxyphenyl) octane, 1,1-bis(4-hydroxyphenyl) propane, 1,1-bis(4-hydroxyphenyl) n-butane, 2,2-bis(4-hydroxy-1-methylphenyl) propane, 1,1-bis(4-hydroxy-t-butylphenyl) propane, 3,3-bis(4-hydroxyphenyl) phthalimidine, 2-phenyl-3,3-bis(4-hydroxyphenyl) phthalimidine (PPPBP), and 1,1-bis(4-hydroxy-3-methylphenyl)cyclohexane (DMBPC). Combinations comprising at least one of the foregoing dihydroxy compounds can also be used.

Branched polycarbonates are also useful, as well as blends of a linear polycarbonate and a branched polycarbonate. The branched polycarbonates can be prepared by adding a branching agent during polymerization. These branching agents include polyfunctional organic compounds containing at least three functional groups selected from hydroxyl, carboxyl, carboxylic anhydride, haloformyl, and mixtures of the foregoing functional groups. Specific examples include trimellitic acid, trimellitic anhydride, trimellitic trichloride, tris-p-hydroxy phenyl ethane, isatin-bis-phenol, tris-phenol TC (1,3,5-tris((p-hydroxyphenyl)isopropyl)benzene), tris-phenol PA (4(4(1,1-bis(p-hydroxyphenyl)-ethyl) alpha, alpha-dimethyl benzyl)phenol), 4-chloroformyl phthalic anhydride, trimesic acid, and benzophenone tetracarboxylic acid. The branching agents can be added at a level of about 0.05 to about 2.0 wt. %. All types of polycarbonate end groups are contemplated as being useful in the polycarbonate composition, provided that such end groups do not significantly affect desired properties of the polycarbonate compositions.

In one specific embodiment, the polycarbonate is a linear homopolymer derived from bisphenol A, in which each of A¹ and A² is p-phenylene and Y¹ is isopropylidene. The polycarbonates can have an intrinsic viscosity, as determined in chloroform at 25° C. of about 0.3 to about 1.5 deciliters per gram (dl/g), specifically about 0.45 to about 1.0 dl/g. The polycarbonates can have a weight average molecular weight of about 10,000 to about 200,000, specifically about 20,000 to about 100,000 as measured by gel permeation chromatography (“GPC”) using a crosslinked styrene-divinylbenzene GPC column, a sample concentration of 1 mg/ml, and as calibrated using polycarbonate standards. Polymer molecular weights, as disclosed herein, are in atomic mass units (AMU).

In one embodiment, the polycarbonate has flow properties suitable for the manufacture of thin (less than 200 mil, or 5,080 micrometer) articles, such as, for example, multilayer films. Melt volume flow rate (often abbreviated MVR) measures the rate of extrusion of a thermoplastics through an orifice at a prescribed temperature and load. Polycarbonates suitable for the formation of thin articles can have an MVR, measured at 300° C. and 1.2 Kg, of about 0.4 to about 25 cubic centimeters per 10 minutes (cc/10 min), specifically about 1 to about 15 cc/10 min. Mixtures of polycarbonates of different flow properties can be used to achieve the overall desired flow property.

“Polycarbonates” and “polycarbonate resins” as used herein further includes combinations of polycarbonates with other copolymers comprising carbonate chain units. As used herein, a “combination” is inclusive of all mixtures, blends, alloys, reaction products, and the like. A specific suitable copolymer is a polyester carbonate, also referred to as a polyester-polycarbonate. Such copolymers further contain, in addition to recurring carbonate chain units of the formula (1), repeating units of formula (6): 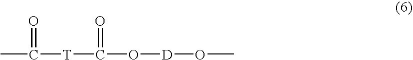
wherein D is a divalent radical derived from a dihydroxy compound, and can be, for example, a C₂₋₁₀ alkylene radical, a C₆₋₂₀ alicyclic radical, a C₆₋₂₀ aromatic radical or a polyoxyalkylene radical in which the alkylene groups contain 2 to about 6 carbon atoms, specifically 2, 3, or 4 carbon atoms; and T divalent radical derived from a dicarboxylic acid, and can be, for example, a C₂₋₁₀ alkylene radical, a C₆₋₂₀ alicyclic radical, a C₆₋₂₀ alkyl aromatic radical, or a C₆₋₂₀ aromatic radical.

In one embodiment, D is a C₆₋₂₀ alkylene radical. In another embodiment, D is derived from an aromatic dihydroxy compound of formula (7): 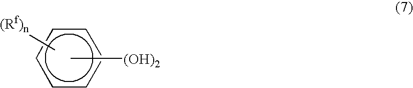
wherein each R^{f} is independently a halogen atom, a C₂₋₁₀ hydrocarbon group, or a C₂₋₁₀ halogen substituted hydrocarbon group, and n is 0 to 4. The halogen is usually bromine. Examples of compounds that can be represented by the formula (7) include resorcinol, substituted resorcinol compounds such as 5-methyl resorcinol, 5-ethyl resorcinol, 5-propyl resorcinol, 5-butyl resorcinol, 5-t-butyl resorcinol, 5-phenyl resorcinol, 5-cumyl resorcinol, 2,4,5,6-tetrafluoro resorcinol, 2,4,5,6-tetrabromo resorcinol, or the like; catechol; hydroquinone; substituted hydroquinones such as 2-methyl hydroquinone, 2-ethyl hydroquinone, 2-propyl hydroquinone, 2-butyl hydroquinone, 2-t-butyl hydroquinone, 2-phenyl hydroquinone, 2-cumyl hydroquinone, 2,3,5,6-tetramethyl hydroquinone, 2,3,5,6-tetra-t-butyl hydroquinone, 2,3,5,6-tetrafluoro hydroquinone, 2,3,5,6-tetrabromo hydroquinone, and the like; and combinations comprising at least one of the foregoing compounds.

Examples of aromatic dicarboxylic acids that can be used to prepare the polyesters include isophthalic or terephthalic acid, 1,2-di(p-carboxyphenyl)ethane, 4,4′-dicarboxydiphenyl ether, 4,4′-bisbenzoic acid, and mixtures comprising at least one of the foregoing acids. Acids containing fused rings can also be present, such as in 1,4-, 1,5-, or 2,6-naphthalenedicarboxylic acids. Specific dicarboxylic acids are terephthalic acid, isophthalic acid, naphthalene dicarboxylic acid, cyclohexane dicarboxylic acid, or mixtures thereof. A specific dicarboxylic acid comprises a mixture of isophthalic acid and terephthalic acid wherein the weight ratio of terephthalic acid to isophthalic acid is about 91:9 to about 2:98. In another specific embodiment, D is a C₂₋₆ alkylene radical and T is p-phenylene, m-phenylene, naphthalene, a divalent cycloaliphatic radical, or a mixture thereof. This class of polyester includes the poly(alkylene terephthalates).

In a specific embodiment, a polyester-polycarbonate may include polyester units comprising ester groups of formula 6, wherein T is derived from a radical derived from isophthalate, terephthalate, or combination of these, and D is a radical derived from a resorcinol of formula 7. In another specific embodiment, D of formula 6 is a radical derived from a bisphenol of formula 4. In another embodiment, a suitable carbonate unit of the polyester-polycarbonate can be derived from a dihydroxy compound of formula 4. In a specific embodiment, a dihydroxy compound can be bisphenol A, in which each of A¹ and A² in formula 3 is p-phenylene and Y¹ is isopropylidene. The polyester-polycarbonate can comprise polyester units and polycarbonate units in a weight ratio, respectively, of about 1:99 to about 75:25, specifically about 5:95 to about 60:40. Suitable polyester-polycarbonates can have a weight averaged molecular weight of about 2,000 to about 100,000, specifically about 3,000 to about 50,000 as measured by gel permeation chromatography as described above. Polyester-polycarbonates suitable for use herein can have an MVR, measured at 300° C. and 1.2 Kg, of about 0.4 to about 25 cubic centimeters per 10 minutes (cc/10 min), specifically about 1 to about 15 cc/10 min.

Suitable polycarbonates can be manufactured by processes such as interfacial polymerization and melt polymerization. Although the reaction conditions for interfacial polymerization can vary, an exemplary process generally involves dissolving or dispersing a dihydric phenol reactant in aqueous caustic soda or potash, adding the resulting mixture to a suitable water-immiscible solvent medium, and contacting the reactants with a carbonate precursor in the presence of a suitable catalyst such as triethylamine or a phase transfer catalyst, under controlled pH conditions, e.g., about 8 to about 10. The most commonly used water immiscible solvents include methylene chloride, 1,2-dichloroethane, chlorobenzene, toluene, and the like. Suitable carbonate precursors include, for example, a carbonyl halide such as carbonyl bromide or carbonyl chloride, or a haloformate such as a bishaloformates of a dihydric phenol (e.g., the bischloroformates of bisphenol A, hydroquinone, or the like) or a glycol (e.g., the bishaloformate of ethylene glycol, neopentyl glycol, polyethylene glycol, or the like). Combinations comprising at least one of the foregoing types of carbonate precursors can also be used.

Among the phase transfer catalysts that can be used are catalysts of the formula (R³)₄Q⁺X, wherein each R³ is the same or different, and is a C₁₋₁₀ alkyl group; Q is a nitrogen or phosphorus atom; and X is a halogen atom or a C₁₋₈ alkoxy group or C₆₋₁₈₈ aryloxy group. Suitable phase transfer catalysts include, for example, [CH₃(CH₂)₃]₄NX, [CH₃(CH₂)₃]₄PX, [CH₃(CH₂)₅]₄NX, [CH₃(CH₂)₆]₄NX, [CH₃(CH₂)₄]₄NX, CH₃[CH₃(CH₂)₃]₃NX, and CH₃[CH₃(CH₂)₂]₃NX, wherein X is Cl⁻, Br⁻, a C₁₋₈ alkoxy group or a C₆₋₁₈ aryloxy group. An effective amount of a phase transfer catalyst can be about 0.1 to about 10 wt. % based on the weight of bisphenol in the phosgenation mixture. In another embodiment an effective amount of phase transfer catalyst can be about 0.5 to about 2 wt. % based on the weight of bisphenol in the phosgenation mixture.

Alternatively, melt processes can be used to make the polycarbonates. Generally, in the melt polymerization process, polycarbonates can be prepared by co-reacting, in a molten state, the dihydroxy reactant(s) and a diaryl carbonate ester, such as diphenyl carbonate, in the presence of a transesterification catalyst in a Banbury® mixer, twin screw extruder, or the like to form a uniform dispersion. Volatile monohydric phenol is removed from the molten reactants by distillation and the polymer is isolated as a molten residue.

Polyester-polycarbonates can also be prepared by interfacial polymerization. Rather than utilizing the dicarboxylic acid per se, it is desirable to use the reactive derivatives of the acid, such as the corresponding acid halides, specifically the acid dichlorides and the acid dibromides. Thus, for example instead of using isophthalic acid and/or terephthalic acid, it is possible to employ isophthaloyl dichloride, terephthaloyl dichloride, or a mixture comprising at least one of these.

In addition to the polycarbonates described above, it is also possible to use combinations comprising at least one of the foregoing polycarbonates with other thermoplastic polymers, for example combinations comprising polycarbonates and/or polycarbonate copolymers with polyesters. Suitable polyesters comprise repeating units of formula (6), and can be, for example, poly(alkylene dicarboxylates), liquid crystalline polyesters, and polyester copolymers. It is also possible to use a branched polyester in which a branching agent, for example, a glycol having three or more hydroxyl groups or a trifunctional or multifunctional carboxylic acid has been incorporated. Furthermore, it is sometime desirable to have various concentrations of acid and hydroxyl end groups on the polyester, depending on the ultimate end use of the composition.

Where used, suitable polyesters include poly(alkylene terephthalates). Specific examples of suitable poly(alkylene terephthalates) are poly(ethylene terephthalate) (PET), poly(1,4-butylene terephthalate) (PBT), poly(ethylene naphthanoate) (PEN), poly(butylene naphthanoate), (PBN), poly(propylene terephthalate) (PPT), poly(cyclohexanedimethanol terephthalate) (PCT), and combinations comprising at least one of the foregoing polyesters. Also useful are poly(cyclohexanedimethanol terephthalate)-co-poly(ethylene terephthalate), abbreviated as PETG wherein the polymer comprises greater than or equal to 50 mole % of poly(ethylene terephthalate), and abbreviated as PCTG, wherein the polymer comprises greater than 50 mole % of poly(cyclohexanedimethanol terephthalate). The above polyesters can include the analogous aliphatic polyesters such as poly(alkylene cyclohexanedicarboxylate), a suitable example of which is poly(1,4-cyclohexylenedimethylene-1,4-cyclohexanedicarboxylate) (PCCD). Also contemplated are the above polyesters with a minor amount, e.g., about 0.5 to about 10 percent by weight, of units derived from an aliphatic diacid and/or an aliphatic polyol to make copolyesters.

The polycarbonate composition can further comprise a polysiloxane-polycarbonate copolymer. The polysiloxane blocks of the copolymer comprise repeating polydiorganosiloxane units of formula (8): 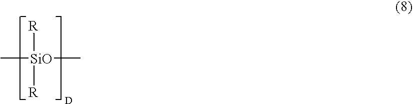
wherein each occurrence of R is same or different, and is a C₁₋₁₃ monovalent organic radical. For example, R can be a C₁-C₁₃ alkyl group, C₁-C₁₃ alkoxy group, C₂-C₁₃ alkenyl group, C₂-C₁₃ alkenyloxy group, C₃-C₆ cycloalkyl group, C₃-C₆ cycloalkoxy group, C₆-C₁₄ aryl group, C₆-C₁₀ aryloxy group, C₇-C₁₃ aralkyl group, C₇-C₁₃ aralkoxy group, C₇-C₁₃ alkaryl group, or C₇-C₁₃ alkaryloxy group. The foregoing groups can be fully or partially halogenated with fluorine, chlorine, bromine, or iodine, or a combination comprising at least one of the foregoing halogens. Combinations comprising at least one of the foregoing R groups can be used in the same copolymer.

The value of D in formula (8) can vary widely depending on the type and relative amount of each component in the polycarbonate composition, the desired properties of the composition, and like considerations. Generally, D can have an average value of about 2 to about 1,000, specifically about 2 to about 500, more specifically about 5 to about 100. In one embodiment, D has an average value of about 10 to about 75, and in still another embodiment, D has an average value of about 40 to about 60. Where D is of a lower value, e.g., less than about 40, it can be desirable to use a relatively larger amount of the polycarbonate-polysiloxane copolymer. Conversely, where D is of a higher value, e.g., greater than or equal to 40, it can be necessary to use a relatively lower amount of the polycarbonate-polysiloxane copolymer.

A combination of a first and a second (or more) polycarbonate-polysiloxane copolymers can be used, wherein the average value of D of the first copolymer is less than the average value of D of the second copolymer.

In one embodiment, the polydiorganosiloxane blocks are provided by repeating structural units of formula (9): 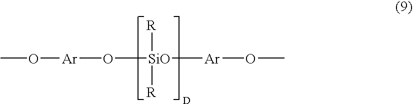
wherein D is as defined above; each R can be the same or different, and is as defined above; and Ar can be the same or different, and is a substituted or unsubstituted C₆-C₃₀ arylene radical, wherein the bonds are directly connected to an aromatic moiety. Suitable Ar groups in formula (9) can be derived from a C₆-C₃₀ dihydroxyarylene compound, for example a dihydroxyarylene compound of formula (3), (4), or (7) above. Combinations comprising at least one of the foregoing dihydroxyarylene compounds can also be used. Specific examples of suitable dihydroxyarlyene compounds are 1,1-bis(4-hydroxyphenyl) methane, 1,1-bis(4-hydroxyphenyl) ethane, 2,2-bis(4-hydroxyphenyl) propane, 2,2-bis(4-hydroxyphenyl) butane, 2,2-bis(4-hydroxyphenyl) octane, 1,1-bis(4-hydroxyphenyl) propane, 1,1-bis(4-hydroxyphenyl) n-butane, 2,2-bis(4-hydroxy- 1-methylphenyl) propane, 1,1-bis(4-hydroxyphenyl) cyclohexane, bis(4-hydroxyphenyl sulphide), and 1,1-bis(4-hydroxy-t-butylphenyl) propane. Combinations comprising at least one of the foregoing dihydroxy compounds can also be used.

Such units can be derived from the corresponding dihydroxy compound of formula (10): 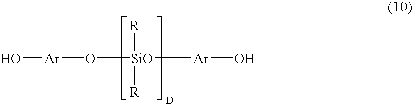
wherein Ar and D are as described above. Compounds of formula (10) can be obtained by the reaction of a dihydroxyarylene compound with, for example, an alpha, omega-bisacetoxypolydiorangonosiloxane under phase transfer conditions.

In another embodiment, polydiorganosiloxane blocks comprises units of formula (11): 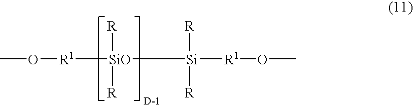
wherein R and D are as described above, each occurrence of R¹ is independently a divalent C₁-C₃₀ organic radical, and wherein the polymerized polysiloxane unit is the reaction residue of its corresponding dihydroxy compound. In a specific embodiment, the polydiorganosiloxane blocks are provided by repeating structural units of formula (12): 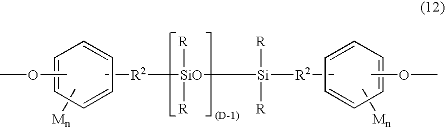
wherein R and D are as defined above. R² in formula (12) is a divalent C₂-C₈ aliphatic group. Each M in formula (12) can be the same or different, and can be a halogen, cyano, nitro, C₁-C₈ alkylthio, C₁-C₈ alkyl, C₁-C₈ alkoxy, C₂-C₈ alkenyl, C₂-C₈ alkenyloxy group, C₃-C₈ cycloalkyl, C₃-C₈ cycloalkoxy, C₆-C₁₀ aryl, C₆-C₁₀ aryloxy, C₇-C₁₂ aralkyl, C₇-C₁₂ aralkoxy, C₇-C₁₂ alkaryl, or C₇-C₁₂ alkaryloxy, wherein each n is independently 0, 1, 2, 3, or4.

In one embodiment, M is bromo or chloro, an alkyl group such as methyl, ethyl, or propyl, an alkoxy group such as methoxy, ethoxy, or propoxy, or an aryl group such as phenyl, chlorophenyl, or tolyl; R² is a dimethylene, trimethylene or tetramethylene group; and R is a C₁₋₈ alkyl, haloalkyl such as trifluoropropyl, cyanoalkyl, or aryl such as phenyl, chlorophenyl or tolyl. In another embodiment, R is methyl, or a mixture of methyl and trifluoropropyl, or a mixture of methyl and phenyl. In still another embodiment, M is methoxy, n is one, R² is a divalent C₁-C₃ aliphatic group, and R is methyl.

Units of formula (12) can be derived from the corresponding dihydroxy polydiorganosiloxane (13): 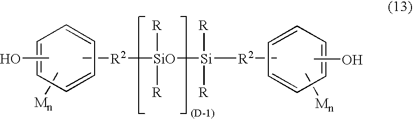
wherein R, D, M, R², and n are as described above. Such dihydroxy polysiloxanes can be made by effecting a platinum catalyzed addition between a siloxane hydride of formula (14): 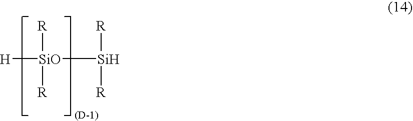
wherein R and D are as previously defined, and an aliphatically unsaturated monohydric phenol. Suitable aliphatically unsaturated monohydric phenols include, for example, but are not limited to, eugenol, 2-alkylphenol, 4-allyl-2-methylphenol, 4-allyl-2-phenylphenol, 4-allyl-2-bromophenol, 4-allyl-2-t-butoxyphenol, 4-phenyl-2-phenylphenol, 2-methyl-4-propylphenol, 2-allyl-4,6-dimethylphenol, 2-allyl-4-bromo-6-methylphenol, 2-allyl-6-methoxy-4-methylphenol and 2-allyl-4,6-dimethylphenol, and a mixture comprising at least one of the foregoing.

The polysiloxane-polycarbonate can comprise polysiloxane units and polycarbonate units in a weight ratio, respectively, of about 1:99 to about 50:50, specifically about 3:97 to about 30:70. Suitable polysiloxane-polycarbonates can have a weight averaged molecular weight of about 2,000 to about 100,000, specifically about 3,000 to about 50,000 as measured by gel permeation chromatography as described above. Polysiloxane-polycarbonates suitable for use herein can have an MVR, measured at 300° C. and 1.2 Kg, of about 0.4 to about 25 cubic centimeters per 10 minutes (cc/10 min), specifically about 1 to about 15 cc/10 min.

The polycarbonate composition can comprise a filler dispersed therein, to convey added properties to an article prepared therefrom. The fillers can include low-aspect ratio fillers, fibrous fillers, and polymeric fillers. Non-limiting examples of fillers include silica powder, such as fused silica, crystalline silica, natural silica sand, and various silane-coated silicas; boron-nitride powder and boron-silicate powders; alumina and magnesium oxide (or magnesia); wollastonite including surface-treated wollastonite; calcium sulfate (as, for example, its anhydride, dihydrate or trihydrate); calcium carbonates including chalk, limestone, marble and synthetic, precipitated calcium carbonates, generally in the form of a ground particulate which often comprises 98+% CaCO₃ with the remainder being other inorganics such as magnesium carbonate, iron oxide and alumino-silicates; surface-treated calcium carbonates; talc, including fibrous, modular, needle shaped, and lamellar talcs; glass spheres, both hollow and solid, and surface-treated glass spheres having coupling agents such as silane coupling agents and/or containing a conductive coating; kaolin, including hard, soft, calcined kaolin, and kaolin comprising various coatings which can facilitate dispersion in and compatibility with the thermoset resin; mica, including metallized mica and mica surface treated with aminosilanes or acryloylsilanes coatings to impart good physical properties to compounded blends; feldspar and nepheline syenite; silicate spheres; flue dust; cenospheres; fillite; aluminosilicate (armospheres), including silanized and metallized aluminosilicate; quartz; quartzite; perlite; diatomaceous earth; silicon carbide; molybdenum sulfide; zinc sulfide; aluminum silicate (mullite); synthetic calcium silicate; zirconium silicate; barium titanate; barium ferrite; barium sulfate and heavy spar; particulate or fibrous aluminum, bronze, zinc, copper and nickel; carbon black, including conductive carbon black; graphite, such as graphite powder; flaked fillers and reinforcements such as glass flakes, flaked silicon carbide, aluminum diboride, aluminum flakes, and steel flakes; processed inorganic fibers such as those derived from blends comprising at least one of aluminum silicates, aluminum oxides, magnesium oxides, and calcium sulfate hemihydrate; natural fibers including wood flour, cellulose, cotton, sisal, jute, starch, cork flour, lignin, ground nut shells, corn, rice grain husks; synthetic reinforcing fibers, including polyester fibers such as polyethylene terephthalate fibers, polyvinylalcohol fibers, aromatic polyamide fibers, polybenzimidazole fibers, polyimide fibers, polyphenylene sulfide fibers, polyether ether ketone fibers, boron fibers, ceramic fibers such as silicon carbide, fibers from mixed oxides of aluminum, boron and silicon; single crystal fibers or “whiskers” including silicon carbide fibers, alumina fibers, boron carbide fibers, iron fibers, nickel fibers, copper fibers; glass fibers, including textile glass fibers such as E, A, C, ECR, R, S, D, and NE glasses, and quartz; vapor-grown carbon fibers include those having an average diameter of about 3.5 to about 500 nanometers.

Specifically, useful fillers possess shape and dimensional qualities suitable to the reflection and/or refraction of light. Visual effect fillers i.e., fillers having light-reflecting an/or refracting properties, include those having planar facets and can be multifaceted or in the form of flakes, shards, plates, leaves, wafers, and the like. The shape can be irregular or regular. A non-limiting example of a regular shape is a hexagonal plate. Specifically suitable visual effect fillers are two dimensional, plate-type fillers, wherein a particle of a plate type filler has a ratio of its largest dimension to smallest dimension of greater than or equal to about 3:1, specifically greater than or equal to about 5:1, and more specifically greater than or equal to about 10:1. The largest dimension so defined can also be referred to as the diameter of the particle. Plate-type fillers have a distribution of particle diameters described by a minimum and a maximum particle diameter. The minimum particle diameter is described by the lower detection limit of the method used to determine particle diameter, and corresponds to it. A typical method of determining particle diameters is laser light scattering, which can for example have a lower detection limit for particle diameter of 0.6 nanometers. It should be noted that particles having a diameter less than the lower detection limit may be present but not observable by the method. The maximum particle diameter is typically less than the upper detection limit of the method. The maximum particle diameter herein may be less than or equal to about 1,000 micrometers, specifically less than or equal to about 750 micrometers, and more specifically less than or equal to about 500 micrometers. The distribution of particle diameters can be unimodal, bimodal, or multimodal. The diameter can be described more generally using the mean of the distribution of the particle diameters, also referred to as the mean diameter. Specifically, particles suitable for use herein have a mean diameter of about 1 to about 100 micrometers, specifically about 5 to about 75 micrometers, and more specifically about 10 to about 60 micrometers. Specific reflective fillers are further of a composition having an optically dense surface exterior finish useful for reflecting incident light. Metallic and non-metallic fillers such as those based on aluminum, silver, copper, bronze, steel, brass, gold, tin, silicon, alloys of these, combinations comprising at least one of the foregoing metals, and the like, are specifically useful. Also specifically useful are inorganic fillers prepared from a composition presenting a surface that is useful for reflecting and/or refracting incident light. In contrast to a reflective filler, a refractive filler having refractive properties can be at least partially transparent, i.e., can allow transmission of a percentage of incident light, and can provide optical properties based on reflection, refraction, or a combination of reflection and refraction of incident light. Inorganic fillers having light reflecting and/or refracting properties suitable for use herein may include micas, alumina, lamellar talc, silica, silicon carbide, glass, combinations comprising at least one of the foregoing inorganic fillers, and the like.

The above fillers can be coated with, for example, metallic coatings and/or silane coatings, to adjust the reflectivity and/or refractivity, or increase compatibility with and adhesion to the polycarbonate.

The filler, including visual effect filler, can be used in the polycarbonate composition in an amount of about 0.01 to about 25 parts by weight, specifically about 0.05 to about 10 parts by weight, and more specifically about 0.1 to about 5 parts by weight, per 100 parts by weight of polycarbonate resin.

The polycarbonate composition can comprise a colorant, such as dyes, pigments, and the like. Suitable dyes include, for example, organic dyes such as coumarin 460 (blue), coumarin 6 (green), nile red or the like; lanthanide complexes; hydrocarbon and substituted hydrocarbon dyes; polycyclic aromatic hydrocarbons; scintillation dyes (specifically oxazoles and oxadiazoles); aryl- or heteroaryl-substituted poly (2-8 olefins); carbocyanine dyes; phthalocyanine dyes and pigments; oxazine dyes; carbostyryl dyes; porphyrin dyes; acridine dyes; anthraquinone dyes; arylmethane dyes; azo dyes; diazonium dyes; nitro dyes; quinone imine dyes; tetrazolium dyes; thiazole dyes; perylene dyes, perinone dyes; bis-benzoxazolylthiophene (BBOT); and xanthene dyes; fluorophores such as anti- stokes shift dyes which absorb in the near infrared wavelength and emit in the visible wavelength, or the like; luminescent dyes such as 5-amino-9-diethyliminobenzo(a)phenoxazonium perchlorate; 7-amino-4-methylcarbostyryl; 7-amino-4-methylcoumarin; 7-amino-4-trifluoromethylcoumarin; 3-(2′-benzimidazolyl)-7-N,N-diethylaminocoumarin; 3-(2′-benzothiazolyl)-7-diethylaminocoumarin; 2-(4-biphenylyl)-5-(4-t-butylphenyl)- 1,3,4-oxadiazole; 2-(4-biphenylyl)-5-phenyl- 1,3,4-oxadiazole; 2-(4-biphenyl)-6-phenylbenzoxazole-1,3; 2,5-Bis-(4-biphenylyl)-1,3,4-oxadiazole; 2,5-bis-(4-biphenylyl)-oxazole; 4,4′-bis-(2-butyloctyloxy)-p-quaterphenyl; p-bis(o-methylstyryl)-benzene; 5,9-diaminobenzo(a)phenoxazonium perchlorate; 4-dicyanomethylene-2-methyl-6-(p-dimethylaminostyryl)-4H-pyran; 1,1 ′-diethyl-2,2′-carbocyanine iodide; 1,1′-diethyl-4,4′-carbocyanine iodide; 3,3′-diethyl-4,4′,5,5′-dibenzothiatricarbocyanine iodide; 1,1′-diethyl-4,4′-dicarbocyanine iodide; 1,1′-diethyl-2,2′-dicarbocyanine iodide; 3,3′-diethyl-9,11-neopentylenethiatricarbocyanine iodide; 1,3′-diethyl-4,2′-quinolyloxacarbocyanine iodide; 1,3′-diethyl-4,2′-quinolylthiacarbocyanine iodide; 3-diethylamino-7-diethyliminophenoxazonium perchlorate; 7-diethylamino-4-methylcoumarin; 7-diethylamino-4-trifluoromethylcoumarin; 7-diethylaminocoumarin; 3,3′-diethyloxadicarbocyanine iodide; 3,3′-diethylthiacarbocyanine iodide; 3,3′-diethylthiadicarbocyanine iodide; 3,3′-diethylthiatricarbocyanine iodide; 4,6-dimethyl-7-ethylaminocoumarin; 2,2′-dimethyl-p-quaterphenyl; 2,2-dimethyl-p-terphenyl; 7-dimethylamino- 1-methyl-4-methoxy-8-azaquinolone-2; 7-dimethylamino-4-methylquinolone-2; 7-dimethylamino-4-trifluoromethylcoumarin; 2-(4-(4-dimethylaminophenyl)- 1,3-butadienyl)-3-ethylbenzothiazolium perchlorate; 2-(6-(p-dimethylaminophenyl)-2,4-neopentylene-1,3,5-hexatrienyl)-3-methylbenzothiazolium perchlorate; 2-(4-(p-dimethylaminophenyl)-1,3-butadienyl)-1,3,3-trimethyl-3H-indolium perchlorate; 3,3′-dimethyloxatricarbocyanine iodide; 2,5-diphenylfuran; 2,5-diphenyloxazole; 4,4′-diphenylstilbene; 1-ethyl-4-(4-(p-dimethylaminophenyl)-1,3-butadienyl)-pyridinium perchlorate; 1-ethyl-2-(4-(p-dimethylaminophenyl)-1,3-butadienyl)-pyridinium perchlorate; 1-Ethyl-4-(4-(p-dimethylaminophenyl)-1,3 -butadienyl)-quinolium perchlorate; 3-ethylamino-7-ethylimino-2,8-dimethylphenoxazin-5-ium perchlorate; 9-ethylamino-5-ethylamino-10-methyl-SH-benzo(a) phenoxazonium perchlorate; 7-ethylamino-6-methyl-4-trifluoromethylcoumarin; 7-ethylamino-4-trifluoromethylcoumarin; 1,1′,3,3,3′,3′-hexamethyl-4,4′,5,5′-dibenzo-2,2′-indotricarboccyanine iodide; 1,1′,3,3,3′,3′-hexamethylindodicarbocyanine iodide; 1,1′,3,3,3′,3′-hexamethylindotricarbocyanine iodide; 2-methyl-5-t-butyl-p-quaterphenyl; N-methyl-4-trifluoromethylpiperidino-<3,2-g>coumarin; 3-(2′-N-methylbenzimidazolyl)-7-N,N-diethylaminocoumarin; 2-(1-naphthyl)-5-phenyloxazole; 2,2′-p-phenylen-bis(5-phenyloxazole); 3,5,3″″,5″″-tetra-t-butyl-p-sexiphenyl; 3,5,3″″,5″″-tetra-t-butyl-p-quinquephenyl; 2,3,5,6-1 H,4H-tetrahydro-9-acetylquinolizino-<9,9a, 1-gh> coumarin; 2,3,5,6-1 H,4H-tetrahydro-9-carboethoxyquinolizino-<9,9a, 1-gh>coumarin; 2,3,5,6-1 H,4H-tetrahydro-8-methylquinolizino-<9,9a, 1-gh> coumarin; 2,3,5,6-1 H,4H-tetrahydro-9-(3-pyridyl)-quinolizino-<9,9a, 1-gh> coumarin; 2,3,5,6-1 H,4H-tetrahydro-8-trifluoromethylquinolizino-<9,9a, 1-gh> coumarin; 2,3,5,6-1 H,4H-tetrahydroquinolizino-<9,9a,1-gh> coumarin; 3,3′,2″,3′″-tetramethyl-p-quaterphenyl; 2,5,2″″,5′″-tetramethyl-p-quinquephenyl; P-terphenyl; P-quaterphenyl; nile red; rhodamine 700; oxazine 750; rhodamine 800; IR 125; IR 144; IR 140; IR 132; IR 26; IR5; diphenylhexatriene; diphenylbutadiene; tetraphenylbutadiene; naphthalene; anthracene; 9,10-diphenylanthracene; pyrene; chrysene; rubrene; coronene; phenanthrene; and the like; and combinations comprising at least one of the foregoing dyes.

Suitable colorants include, for example titanium dioxide, anthraquinones, perylenes, perinones, indanthrones, quinacridones, xanthenes, oxazines, oxazolines, thioxanthenes, indigoids, thioindigoids, naphtalimides, cyanines, xanthenes, methines, lactones, coumarins, bis-benzoxaxolylthiophenes (BBOT), napthalenetetracarboxylic derivatives, monoazo and disazo pigments, triarylmethanes, aminoketones, bis(styryl)biphenyl derivatives, and the like, as well as combinations comprising at least one of the foregoing colorants. In one embodiment, a colorant can be present in the polycarbonate composition in an amount of about 0.001 to about 5 parts by weight, specifically about 0.005 to about 3 parts by weight, more specifically about 0.01 to about 1 parts by weight, per 100 parts by weight of polycarbonate resin.

The composition can further comprise a UV absorbing additive. The UV absorbing additive facilitates the preservation of the IR absorbing additive by increasing its hydrolytic stability. Suitable UV absorbing additives are benzophenones such as 2,4 dihydroxybenzophenone, 2-hydroxy-4-methoxybenzophenone, 2-hydroxy-4-n-octoxybenzophenone, 4-dodecyloxy-2 hydroxybenzophenone, 2-hydroxy-4-octadecyloxybenzophenone, 2,2′ dihydroxy-4 methoxybenzophenone, 2,2′ dihydroxy-4,4′dimethoxybenzophenone, 2,2′ dihydroxy-4 methoxybenzophenone, 2,2′,4,4′ tetra hydroxybenzophenone, 2-hydroxy-4-methoxy-5 sulfobenzophenone, 2-hydroxy-4-methoxy-2′-carboxybenzophenone, 2,2′ dihydroxy-4,4′dimethoxy-5 sulfobenzophenone, 2-hydroxy-4-(2-hydroxy-3-methylaryloxy) propoxybenzophenone, 2-hydroxy-4 chlorobenzopheone, or the like; benzotriazoles such as 2-(2-hydroxy-5-tert-octylphenyl)-benzotriazole, 2-hydroxy-4-n-octoxy benzophenone 2-(2-hydroxy-5-methyl phenyl) benzotriazole, 2-(2-hydroxy-3′,5′-di-tert-butyl phenyl) benzotriazole, and 2-(2-hydroxy-X-tert, butyl-5′-methyl-phenyl) benzotriazole, or the like; salicylates such as phenyl salicylate, carboxyphenyl salicylate, p-octylphenyl salicylate, strontium salicylate, p-tert butylphenyl salicylate, methyl salicylate, dodecyl salicylate, or the like; and also other ultraviolet absorbents such as resorcinol monobenzoate, 2 ethyl hexyl-2-cyano, 3-phenylcinnamate, 2-ethyl-hexyl-2-cyano-3,3-diphenyl acrylate, ethyl-2-cyano-3,3-diphenyl acrylate, 2-2′-thiobis(4-t-octylphenolate)-1-n-butylamine, or the like, or combinations comprising at least one of the foregoing UV absorbing additives. Preferred commercially available UV absorbers are Tinuvin™234, TINUVIN™329, TINUVIN™350 and TINUVIN™360, commercially available from Ciba Specialty Chemicals; CYASORB™ UV absorbers, available from Cyanamide, such as 2- (2H-benzotriazol-2-yl)-4-(1,1,3,3-tetramethylbutyl)-phenol (CYASORB™ 5411); 2-hydroxy-4-n-octyloxybenzophenone (CYASORB™ 531); 2-[4,6-bis(2,4-dimethylphenyl)-1,3,5-triazin-2-yl]-5-(octyloxy)-phenol (CYASORB™ 1164); 2,2′-(1,4- phenylene)bis(4H-3,1-benzoxazin-4-one) (CYASORB™ UV-3638); 1,3-bis[(2-cyano-3,3-diphenylacryloyl)oxy]-2,2-bis[[(2-cyano-3,3-diphenylacryloyl)oxy]methyl]propane (UVINUL™ 3030); 2,2′-(1,4-phenylene) bis(4H-3,1-benzoxazin-4-one); 1,3-bis[(2-cyano-3,3-diphenylacryloyl)oxy] -2,2-bis[[(2-cyano-3,3 -diphenylacryloyl)oxy]methyl] propane. For articles formed by extrusion, UVINUL™ 3030, commercially available from BASF, is specifically useful due to its low volatility.

The UV absorbers can be used in the polycarbonate composition in an amount of about 0.1 to about 0.5 parts by weight, specifically about 0.2 to about 0.4 parts by weight, per 100 parts by weight of polycarbonate resin.

The composition can contain thermal stabilizers to compensate for the increase in temperature brought on by the interaction of the IR light with the inorganic infrared shielding additives. Further, the addition of thermal stabilizers protects the material during processing operations such as melt blending. In general, an article comprising thermoplastic polymer containing the inorganic infrared shielding additives may experience an increase in temperature of up to about 20° C. upon exposure to light. The addition of thermal stabilizers to the composition improves the long term aging characteristics and increases the life cycle of the article.

In another embodiment thermal stabilizers may be optionally added to the composition to prevent degradation of the organic polymer during processing and to improve heat stability of the article. Suitable thermal stabilizers include phosphites, phosphonites, phosphines, hindered amines, hydroxyl amines, phenols, acryloyl modified phenols, hydroperoxide decomposers, benzofuranone derivatives, or the like, or combinations comprising at least one of the foregoing thermal stabilizers. Examples include, but are not limited to, phosphites such as tris(nonyl phenyl) phosphite, tris(2,4-di-t-butylphenyl) phosphite, bis(2,4-di-t-butylphenyl) pentaerythritol diphosphite, distearyl pentaerythritol diphosphite or the like; alkylated monophenols or polyphenols; alkylated reaction products of polyphenols with dienes, such as tetrakis[methylene(3,5-di-tert-butyl-4-hydroxyhydrocinnamate)] methane, or the like; butylated reaction products of para-cresol or dicyclopentadiene; alkylated hydroquinones; hydroxylated thiodiphenyl ethers; alkylidene-bisphenols; benzyl compounds; esters of beta-(3,5-di-tert-butyl-4-hydroxyphenyl)-propionic acid with monohydric or polyhydric alcohols; esters of beta-(5-tert-butyl-4-hydroxy-3-methylphenyl)-propionic acid with monohydric or polyhydric alcohols; esters of thioalkyl or thioaryl compounds such as distearylthiopropionate, dilaurylthiopropionate, ditridecylthiodipropionate, octadecyl-3-(3,5-di-tert-butyl-4-hydroxyphenyl)propionate, pentaerythrityl-tetrakis[3-(3,5-di-tert-butyl-4-hydroxyphenyl)propionate or the like; amides of beta-(3,5-di-tert-butyl-4-hydroxyphenyl)-propionic acid or the like, or combinations comprising at least one of the foregoing antioxidants. Suitable thermal stabilizers that are commercially available are IRGAPHOS™ 168, DOVERPHOS™ S9228, ULTRANOX™ 641, or the like. If desirable, an optional co-stabilizer such as a aliphatic epoxy or a hindered phenol anti-oxidant such as IRGANOX™ 1076, IRGANOX™ 1010, both from Ciba Specialty chemicals may also be added to improve thermal stability of the composition. The preferred thermal stabilizers are phosphites.

The thermal stabilizer can be present in the polycarbonate composition in an amount of about 0.001 to about 3 parts by weight, specifically about 0.002 to about 1 parts by weight, per 100 parts by weight of polycarbonate resin.

The polycarbonate composition can also include a flame retardant, generally a halogenated material, an organic phosphate, or a combination comprising at least one of these. For compositions containing polycarbonate, the organic phosphate class of materials is generally useful. The organic phosphate is specifically an aromatic phosphate compound of formula (15): 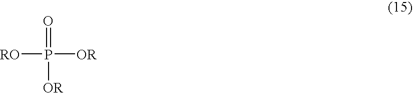
where each instance of R is the same or different and is alkyl, cycloalkyl, aryl, alkyl substituted aryl, halogen substituted aryl, aryl substituted alkyl, halogen, or a combination of any of the foregoing, provided at least one R is aryl.

Examples include phenyl bisdodecyl phosphate, phenylbisneopentyl phosphate, phenyl-bis (3,5,5′-tri-methyl-hexyl phosphate), ethyldiphenyl phosphate, 2-ethyl-hexyldi(p-tolyl) phosphate, bis-(2-ethylhexyl) p-tolylphosphate, tritolyl phosphate, bis-(2-ethylhexyl) phenyl phosphate, tri-(nonylphenyl) phosphate, di (dodecyl) p-tolyl phosphate, tricresyl phosphate, triphenyl phosphate, dibutylphenyl phosphate, 2-chloroethyldiphenyl phosphate, p-tolyl bis(2,5,5′-trimethylhexyl) phosphate, 2-ethylhexyldiphenyl phosphate, and the like. In one embodiment the phosphate is one in which each R is aryl or alkyl substituted aryl.

Alternatively, the organic phosphate can be a di- or polyfunctional compound or polymer having the formula (16), (17), or (18) below: 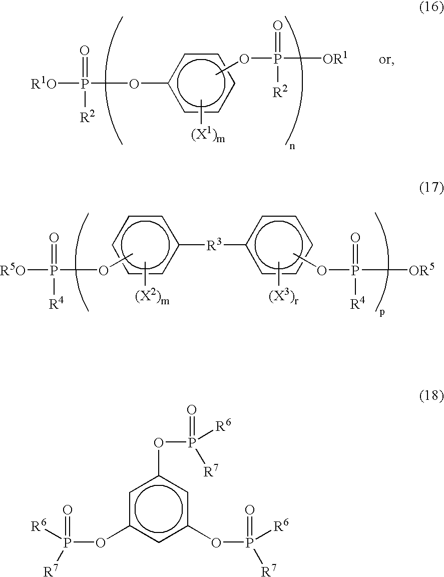
including mixtures thereof, in which R¹, R³ and R⁵ are, independently, hydrocarbon; R², R⁴, R⁶ and R⁷ are, independently, hydrocarbon or hydrocarbonoxy; X¹, X² and X³ are halogen; m and r are 0 or integers from 1 to 4, and n and p are from 1 to 30. Examples include the bis diphenyl phosphates of resorcinol, hydroquinone and bisphenol-A, respectively, or their polymeric counterparts.

Another group of useful flame retardants include certain cyclic phosphates, for example, diphenyl pentaerythritol diphosphate, as a flame retardant agent for polycarbonate resins.

Useful organic phosphates include phosphates containing substituted phenyl groups, phosphates based upon resorcinol such as, for example, resorcinol tetraphenyl diphosphate, as well as those based upon bis-phenols such as, for example, bis-phenol A tetraphenyl diphosphate. In one embodiment, the organic phosphate is selected from the group consisting of butylated triphenyl phosphate, resorcinol diphosphate, bis-phenol A diphosphate, triphenyl phosphate, isopropylated triphenyl phosphate and mixtures of two or more of the foregoing.

Suitable flame-retardant additives include phosphoramides of formula (19): 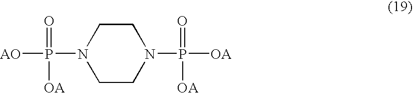
wherein each A moiety is a 2,6-dimethylphenyl moiety or a 2,4,6-trimethylphenyl moiety. These phosphoramides are piperazine-type phosphoramides. When polyamide resins are used as part of the composition, these piperazine-type phosphoramides are especially useful as they are believed to have less interactions with the polyamides then the organo-ester type phosphates.

The flame retardant can be present in at least the minimum amount necessary to impart a degree of flame retardancy to the composition to pass the desired UL-94 protocol. The particular amount will vary, depending on the molecular weight of the organic phosphate, the amount of the flammable resin present and possibly other normally flammable components that can be present.

Halogenated materials are also a useful class of flame retardants. These materials are specifically aromatic halogen compounds and resins of the formula (20): 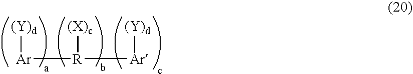
wherein R is an alkylene, alkylidene or cycloaliphatic linkage, e.g., methylene, ethylene, propylene, isopropylene, isopropylidene, butylene, isobutylene, amylene, cyclohexylene, cyclopentylidene, and the like; a linkage selected from the group consisting of either oxygen ether; carbonyl; amine; a sulfur containing linkage, e.g., sulfide, sulfoxide, sulfone; a phosphorus containing linkage; and the like. R can also consist of two or more alkylene or alkylidene linkages connected by such groups as aromatic, amino, ether, carbonyl, sulfide, sulfoxide, sulfone, a phosphorus containing linkage, and the like.

Ar and Ar′ are mono- or polycarbocyclic aromatic groups such as phenylene, biphenylene, terphenylene, naphthylene, and the like. Ar and Ar′ can be the same or different.

Y is a substituent selected from the group consisting of organic, inorganic or organometallic radicals. The substituents represented by Y include: halogen, e.g., chlorine, bromine, iodine, fluorine; or ether groups of the general formula OE, wherein E is a monovalent hydrocarbon radical similar to X; or monovalent hydrocarbon groups of the type represented by R; or other substituents, e.g., nitro, cyano, and the like, said substituents being essentially inert provided there be at least one and specifically two halogen atoms per aryl nucleus.

X is a monovalent hydrocarbon group exemplified by the following: alkyl, such as methyl, ethyl, propyl, isopropyl, butyl, decyl, etc; aryl groups, such as phenyl, naphthyl, biphenyl, xylyl, tolyl, etc; aralkyl groups such as benzyl, ethylphenyl, and the like; cycloaliphatic groups, such as cyclopentyl, cyclohexyl, and the like; as well as monovalent hydrocarbon groups containing inert substituents therein. It will be understood that where more than one X is used they can be alike or different.

The letter d represents a whole number ranging from 1 to a maximum equivalent to the number of replaceable hydrogens substituted on the aromatic rings comprising Ar or Ar′. The letter e represents a whole number ranging from 0 to a maximum controlled by the number of replaceable hydrogens on R. The letters a, b, and c represent whole numbers including 0. Where b is not 0, neither a nor c can be 0. Otherwise either a or c, but not both, can be 0. Where b is 0, the aromatic groups are joined by a direct carbon-carbon bond.

The hydroxyl and Y substituents on the aromatic groups, Ar and Ar′ can be varied in the ortho, meta or para positions on the aromatic rings and the groups can be in any possible geometric relationship with respect to one another.

Included within the scope of the above formula are biphenols of which the following are representative: 2,2-bis-(3,5-dichlorophenyl)-propane; bis-(2-chlorophenyl)-methane; bis(2,6-dibromophenyl)-methane; 1,1-bis-(4-iodophenyl)-ethane; 1,2-bis-(2,6-dichlorophenyl)-ethane; 1,1-bis-(2-chloro-4-iodophenyl)ethane; 1,1-bis-(2-chloro-4-methylphenyl)-ethane; 1,1-bis-(3,5-dichlorophenyl)-ethane; 2,2-bis-(3-phenyl-4-bromophenyl)-ethane; 2,6-bis-(4,6-dichloronaphthyl)-propane; 2,2-bis-(2,6-dichlorophenyl)-pentane; 2,2-bis-(3,5-dichromophenyl)-hexane; bis-(4-chlorophenyl)-phenyl-methane; bis-(3,5-dichlorophenyl)-cyclohexylmethane; bis-(3-nitro-4-bromophenyl)-methane; bis-(4-hydroxy-2,6-dichloro-3-methoxyphenyl)-methane; 2,2-bis-(3,5-dichloro-4-hydroxyphenyl)-propane 2,2 bis-(3-bromo-4-hydroxyphenyl)-propane.

Bisphenols can be prepared by condensation of two moles of a phenol with a single mole of a ketone or aldehyde. In place of the divalent aliphatic group in the above examples can be substituted oxygen, sulfur, sulfoxy, and the like.

Included within the above structural formula are: 1,3-dichlorobenzene, 1,4-dibrombenzene, 1,3-dichloro-4-hydroxybenzene and biphenyls such as 2,2′-dichlorobiphenyl, polybrominated 1,4-diphenoxybenzene, 2,4′-dibromobiphenyl, and 2,4′-dichlorobiphenyl as well as decabromo diphenyl oxide, and the like.

Also useful are oligomeric and polymeric halogenated aromatic compounds, such as, for example, a copolycarbonate of bisphenol A and tetrabromobisphenol A and a carbonate precursor, e.g., phosgene. Metal synergists, e.g., antimony oxide, can also be used with the flame retardant.

Suitable phosphorous flame retardant additives are commercially available or can be prepared according to methods available in the literature. As an example, the compounds can be prepared by reacting a halogenated phosphate compound with various dihydric or trihydric phenolic compounds until the desired number of phosphate functional groups are obtained. Examples of the phenolic compounds are dihydroxy aromatic compounds such as resorcinol and hydroquinone.

Where used, flame retardants may be present in an amount of about 0.5 to about 30 parts by weight, specifically about 7 to about 20 parts by weight, per 100 parts by weight of polycarbonate resin.

While the polycarbonate composition is of a viscosity and flow suitable for the application, it is contemplated that flow promoters and plasticizers can still be desired for certain embodiments. Examples of suitable flow promoters and plasticizers include the phosphate plasticizers such as cresyl diphenyl phosphate, triphenyl phosphate, tricresyl phosphate, isopropylated and triphenyl phosphate. Terepene phenol, saturated alicyclic hydrocarbons, chlorinated biphenols, and mineral oil are also suitable. Where used, plasticizers are can be present in an amount of about 0.1 to about 10 parts by weight per 100 parts by weight of polycarbonate resin.

The polycarbonate composition also optionally includes an anti-drip agent such as a fluoropolymer. The fluoropolymer can be a fibril forming or non-fibril forming fluoropolymer. The fluoropolymer generally used is a fibril forming polymer. In some embodiments the fluoropolymer comprises polytetrafluoroethylene. In some embodiments an encapsulated fluoropolymer can be employed, i.e., a fluoropolymer encapsulated in a polymer. An encapsulated fluoropolymer can be made by polymerizing the polymer in the presence of the fluoropolymer. Alternatively, the fluoropolymer can be pre-blended in some manner with a second polymer, such as for, example, an aromatic polycarbonate resin or a styrene-acrylonitrile resin to form an agglomerated material for use as an anti-drip agent. Either method can be used to produce an encapsulated fluoropolymer. The anti-drip agent, can be present in the polycarbonate composition in an amount of about 0.1 to about 5 parts by weight, specifically about 0.5 to about 3.0 parts by weight, and more specifically about 1.0 to about 2.5 parts by weight, per 100 parts by weight of polycarbonate resin.

The polycarbonate film can also comprise an antistatic agent. The term “antistatic agent” refers to materials that can be either melt-processed into polymeric resins or sprayed onto commercially available polymeric forms and shapes to improve conductive properties and overall physical performance.

Examples of monomeric antistatic agents that can be used are glycerol monostearate, glycerol distearate, glycerol tristearate, ethoxylated amines, primary, secondary and tertiary amines, ethoxylated alcohols, alkyl sulfates, alkylarylsulfates, alkylphosphates, alkylaminesulfates, quaternary ammonium salts, quaternary ammonium resins, imidazoline derivatives, sorbitan esters, ethanolamides, betaines and mixtures of the foregoing. Non-limiting examples of commercial monomeric antistatic agents which can be used in polymeric resins are PATIONIC™ 1042 and PATIONIC™ AS 10 available from Patco or STATEXAN® K1 available from Bayer.

Polymeric materials can also be useful as antistatic agents, and have been shown to have adequate thermal stability and processability in the melt state in their neat form or in blends with other polymeric resins.

Polymeric materials that can be useful as antistatic agents include polyetheramides, polyetheresters, and polyetheresteramides include block copolymers and graft copolymers, both obtained by the reaction between a polyamide-forming compound and/or a polyester-forming compound, and a compound containing a polyalkylene oxide unit. Polyamide forming compounds include aminocarboxylic acids such as ω- aminocaproic acid, ω-aminoenanthic acid, ω-aminocaprylic acid, ω-aminopelargonic acid, ω-aminocapric acid, 11-aminoundecanoic acid and 12-aminododecanoic acid; lactams such as ε-caprolactam and enanthlactam; a salt of a diamine with a dicarboxylic acid, such as hexamethylene diamine adipate, hexamethylene diamine sebacate, and hexamethylene diamine isophthalate; and a mixture comprising at least one of these polyamide-forming compounds. Specifically, the polyamide-forming compound can be a caprolactam, 12-aminododecanoic acid, or a combination of hexamethylene diamine and adipic acid.

Polyesters can also be useful as antistatic agents. Suitable polyesters can be formed using a combination of a dicarboxylic acid (or a mixture of two or more dicarboxylic acids) with an aliphatic diol (or a mixture of two or more aliphatic diols). Non-limiting examples of dicarboxylic acids include aromatic dicarboxylic acids, such as isophthalic acid, terephthalic acid, phthalic acid, naphthalene-2,6-dicarboxylic acid, naphthalene-2,7-dicarboxylic acid, diphenyl-4,4′-dicarboxylic acid, diphenoxyethanedicarboxylic acid and sodium 3-sulfoisophthalate; alicyclic dicarboxylic acids, such as 1,3-cyclopentanedicarboxylic acid, 1,4-cyclohexanedicarboxylic acid, 1,2-cyclohexanedicarboxylic acid and 1,3-dicarboxymethylcyclohexane; and aliphatic dicarboxylic acids, such as succinic acid, oxalic acid, adipic acid, sebacic acid and decanedicarboxylic acid. These dicarboxylic acids can be used individually or in combination. Non-limiting examples of aliphatic diols include ethylene glycol, 1,2-propylene glycol, 1,3-propylene glycol, 1,2-butanediol, 1,3-butanediol, 2,3-butanediol, 1,4-butanediol, neopentyl glycol and hexanediol. These aliphatic diols can be used individually or in combination. Specifically useful dicarboxylic acids include terephthalic acid, isophthalic acid, 1,4-cyclohexanedicarboxylic acid, sebacic acid and decanedicarboxylic acid. Specifically useful diols include ethylene glycol, 1,2-propylene glycol, 1,3-propylene glycol and 1,4-butanediol.

Compounds containing polyalkylene oxide units such as polyethylene glycol, polypropylene glycol, polytetramethylene glycol and a block or random copolymer of ethylene oxide and tetramethylene oxide; diamines obtained by replacing the terminal hydroxyl groups of these diols by amino groups; and dicarboxylic acids obtained by replacing the terminal hydroxyl groups of these diols by carboxylic acid groups can be used to form the polyetheramide, polyetherester and polyetheresteramide polymeric antistatic agents. These compounds containing a polyalkylene oxide unit can be used individually or in combination. Of these compounds, polyethylene glycol is specifically suitable.

Examples of polyamide-polyalkyleneoxide antistatic agents include PELESTAT™ 6321 available from Sanyo, PEBAX™ MH1657 available from Atofina, and IRGASTAT™ P18 and IRGASTAT™ P22 from Ciba-Geigy. Conductive polymers such as polyaniline, polypyrrole, and polythiophene can be used as antistatic agents, and can retain some of their intrinsic conductivity after melt processing at elevated temperatures. A non-limiting example of a polyaniline antistatic agent is PANIPOL®EB from Panipol.

Where used, the antistatic agents can be present in the polycarbonate composition in an amount of about 0.01 to about 25 parts by weight, specifically about 0.1 to about 15 parts by weight, and more specifically about 1 to about 10 parts by weight, per 100 parts by weight of polycarbonate resin.

Radiation stabilizers may also be present in the composition, specifically gamma-radiation stabilizers. Suitable gamma-radiation stabilizers include diols, such as ethylene glycol, propylene glycol, 1,3-propanediol, 1,2-butanediol, 1,4-butanediol, meso-2,3-butanediol, 1,2-pentanediol, 2,3-pentanediol, 1,4-pentanediol, 1,4-hexandiol, and the like; alicyclic alcohols such as 1,2-cyclopentanediol, 1,2-cyclohexanediol, and the like; branched acyclic diols such as 2,3-dimethyl-2,3-butanediol (pinacol), and the like, and polyols, as well as alkoxy-substituted cyclic or acyclic alkanes. Alkenols, with sites of unsaturation, are also a useful class of alcohols, examples of which include 4-methyl-4-penten-2-ol, 3-methyl-pentene-3-ol, 2-methyl-4-penten-2-ol, 2,4-dimethyl-4-pene-2-ol, and 9-decen-1-ol. Another class of suitable alcohols is the tertiary alcohols, which have at least one hydroxy substituted tertiary carbon. Examples of these include 2-methyl-2,4-pentanediol (hexylene glycol), 2-phenyl-2-butanol, 3-hydroxy-3-methyl-2-butanone, 2-phenyl-2-butanol, and the like, and cycoloaliphatic tertiary carbons such as 1-hydroxy-1-methyl-cyclohexane. Another class of suitable alcohols is hydroxymethyl aromatics, which have hydroxy substitution on a saturated carbon attached to an unsaturated carbon in an aromatic ring. The hydroxy substituted saturated carbon may be a methylol group (—CH₂OH) or it may be a member of a more complex hydrocarbon group such as would be the case with (—CR⁴HOH) or (—CR₂⁴OH) wherein R⁴ is a complex or a simply hydrocarbon. Specific hydroxy methyl aromatics may be benzhydrol, 1,3-benzenedimethanol, benzyl alcohol, 4-benzyloxy benzyl alcohol and benzyl benzyl alcohol. Specific alcohols are 2-methyl-2,4-pentanediol (also known as hexylene glycol), polyethylene glycol, polypropylene glycol. Gamma-radiation stabilizing compounds can be used in the polycarbonate composition in amounts of 0.001 to 1 parts by weight, more specifically 0.01 to 0.5 parts by weight, per 100 parts by weight of polycarbonate resin.

Thus, a polycarbonate composition comprises a polycarbonate resin as described above. In an embodiment, where it is desirable for an optical effects filler to be present, a polycarbonate composition having a visual effects filler comprises 100 parts by weight of a polycarbonate resin, and about 0.001 to about 25 parts by weight of a visual effect filler. In a specific embodiment, the visual effect filler is aluminum, mica, or a composition comprising at least one of the foregoing. In a further embodiment, the polycarbonate composition having a visual effects filler can further comprise 0 to about 25 parts by weight of a colorant. The polycarbonate composition can also comprise additional components including UV absorbers, thermal stabilizers, fillers, flame retardants, plasticizers, antistatic agents, gamma ray stabilizers, a combination comprising at least one of the foregoing, and the like, insofar as the presence of additional components does not adversely affect the desired properties of the polycarbonate composition.

The polycarbonate composition has a viscosity, measured at a low shear rate of less than or equal to about 100 sec⁻¹, that is useful for forming a layer of a multilayer film. Specific viscosities of polycarbonate compositions useful for providing multilayer films without streaks are of about 7,000 to about 100,000 Poise (P), specifically about 8,000 to about 90,000 P, and more specifically about 8,500 to about 80,000 P, measured at a shear rate of about 0.1 sec⁻¹ and at a temperature of about 530° F. (about 277° C.), according to ASTM D4440-01.

In a specific embodiment, the polycarbonate composition can have a viscosity, measured at a shear rate of about 0.1 sec⁻¹ at a temperature of about 530° F. (about 277° C.), of about 8,000 to about 22,000 P, specifically about 8,500 to about 21,000 P, and more specifically about 9,000 to about 20,000 P, according to ASTM D4440-01. In another specific embodiment, the polycarbonate composition can have a viscosity, measured at a shear rate of about 0.1 sec⁻¹ and at a temperature of about 530° F. (about 277° C.), of about 22,000 to about 100,000 P, specifically about 23,000 to about 90,000 P, and more specifically about 24,000 to about 80,000 P, according to ASTM D4440-01.

In a similar way, the polycarbonate composition has melt flow rates that provide a multilayer film without streaks. As used herein, “melt flow rate”, also referred to in the art as the “melt flow index” and abbreviated “MFI”, and as “melt volume rate” and abbreviated “MVR”, each refer to the melt flow rate. A useful MVR for the polycarbonate composition is about 1 to about 12 cc/10 min., specifically about 2 to about 11 cc/10 min., more specifically about 2.5 to about 10.5 cc/10 min., and still more specifically about 3 to about 10 cc/10 min., measured at 300° C. and 1.2 Kg. according to ASTM D1238-04.

In a specific embodiment, the polycarbonate composition has an MVR of about 1 to about 5 cc/10 min., specifically about 2 to about 4.75 cc/10 min., more specifically about 2.5 to about 4.5 cc/10 min., and still more specifically about 3 to about 4 cc/10 min., measured at 300° C. and 1.2 Kg according to ASTM D1238-04. In another specific embodiment, the polycarbonate composition has an MVR of about 5 to about 12 cc/10 min., specifically about 6 to about 11 cc/10 min., more specifically about 7 to about 10.5 cc/10 min., and still more specifically about 8 to about 10 cc/10 min., measured at 300° C. and 1.2 Kg according to ASTM D1238-04.

The polycarbonate compositions for use in preparing multilayer films can be manufactured by various methods, for example, in one embodiment, in one manner of proceeding, a powdered polycarbonate resin and any other components are first blended in a HENSCHEL-Mixer® high speed mixer. Other low-shear processes including, but not limited to, hand mixing can also accomplish this blending. The blend is then fed into the throat of a single or twin-screw extruder via a hopper. Alternatively, one or more of the components can be incorporated into the composition by feeding directly into the extruder at the throat and/or downstream through a sidestuffer. Such additives can also be compounded into a masterbatch with a desired polymeric resin and fed into the extruder. The additives can be added to the polycarbonate composition to make a concentrate, before this is added to the final product. The extruder is generally operated at a temperature higher than that necessary to cause the composition to flow, such as, for example, about 500° F. to about 650° F. (about 260° C. to about 343° C.). The extrudate is immediately quenched in a water batch and pelletized. The pellets, prepared by cutting the extrudate, can be about one-fourth inch long or less as desired. Such pellets can be used for subsequent extrusion, casting, molding, shaping, or forming of a film or multilayer film comprising the polycarbonate composition.

A multilayer film is prepared by coextruding a polycarbonate composition having a visual effect filler through a extrusion die to form a layer. The layer is contacted with other layers to form a multilayered extrudate having discrete strata in the die, and the multilayered extrudate is thus extruded as a multilayered film.

The multilayer films are prepared by extrusion using a coextruder, which comprises two or more extruders, and a coextrusion die. The die can be a single channel coextrusion die, e.g., a “coathanger die”, wherein each extruder feeds into a feedblock which combines the flows into a stratified flow, and which in turn feeds the stratified flow into an aperture at the back of the single manifold die. The single manifold die spreads the flow to fill the die and extrude evenly out of an adjustable aperture (also referred to herein as the “die lip”), which is adjusted to provide thickness control of the multilayer films extruded from the die, along the direction of flow.

Alternatively, a multi-channel coextrusion die (also referred to herein as a “multi-manifold coextrusion die”) can be used. A single extruder is used to extrude each individual layer, and the output of each extruder flows into a flow channel of the multi-manifold die. Each flow channel provides a single layer of the final multilayer film. The flow channels, upon entering the die, widen and flatten to provide an internal flow channel having a cross-sectional width coincident with the width of the multilayer films extruded from the die, and to an internal flow channel cross-sectional height proportional to the thickness of the multilayer film to be produced. The cross-sectional height and width are orthogonal to each other, and both the cross-sectional height and width are orthogonal to the direction of flow of the extrudate. A multi-manifold coextrusion die can vary greatly in width (“w”) depending on the film to be produced. In a non-limiting example, the width of the die can be about 36 inches (about 91 centimeters) to about 60 inches (about 152 centimeters) in width, wherein a multilayer film extruded therefrom would have about the same width as the coextrusion die. The cross-sectional heights of the flow channels are generally selected for the desired layer thickness and extrudate throughput, based on the properties of the materials being extruded. The cross-sectional height of the flow channels is dependent upon the application and desired throughput. The cross-sectional height of a flow channel in the die can thus be about 1 to about 200 mil (about 25 to about 5,080 micrometers).

Extruders and coextrusion dies used in the formation of multilayer thin films comprising polycarbonates can be operated at an extrusion temperature of about 400 to about 650° F. (about 204 to about 343° C.), specifically about 425 to about 625° F. (about 218 to about 329° C.), more specifically about 450 to about 600° F. (about 232 to about 315° C.). Extrusion temperature and tolerance of the polycarbonate compositions to temperature variations can be determined for optimal performance in the formation of multilayer films by one skilled in the art. The extruders operate at a shear rate less than or equal to 150 sec⁻¹, specifically less than or equal to about 125 sec⁻¹, and more specifically less than or equal to about 100 sec⁻¹. Vacuum can be applied to the extruder to remove volatiles and provide a multilayer film to reduce or eliminate defects arising from entrapped gas bubbles. Use of vacuum can also induce the extrudate to completely fill the flow channels.

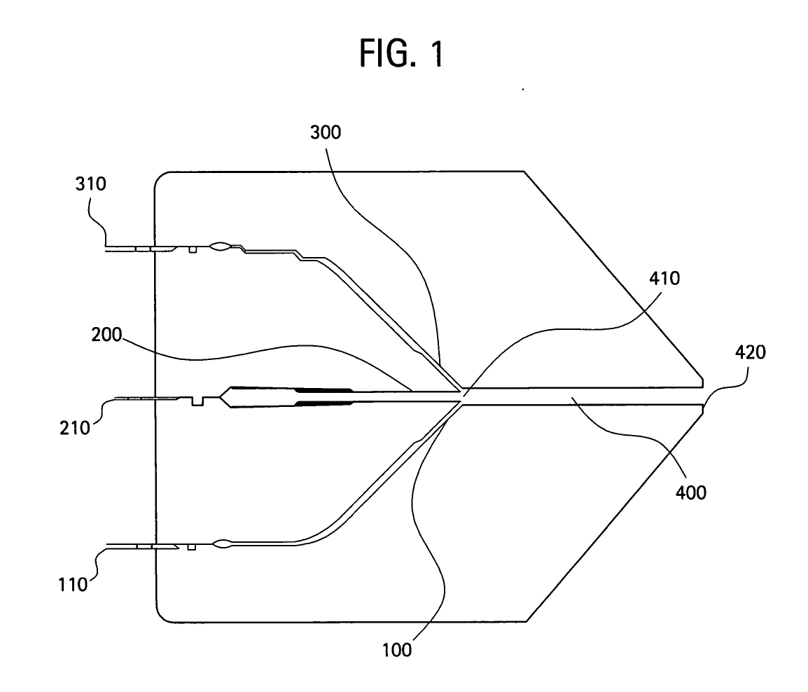

A cross-sectional view orthogonal to the width, and normal to the direction of flow, of a multi-manifold coextrusion die design is shown in FIG. 1 where, in a basic representation, in an embodiment, the die comprises a first flow channel 100, a second flow channel 200, a third flow channel 300, and a combining region 400. Each of the channels and the combining region have a cross-sectional height and a width, where the cross-sectional height and width are each orthogonal to the direction of flow through the flow channels and the combining region, and the cross-sectional height and width are orthogonal to each other. The widths of each of flow channels 100, 200, 300, and of combining region 400 are of approximately equal dimension.

In an embodiment, the multi-manifold coextrusion die has a cross-sectional height for the first flow channel 100 of about 40 to about 80 mil (about 1,016 to about 2,032 micrometers), a cross-sectional height for the second flow channel 200 of about 60 to about 125 mil (about 1,524 to about 3,175 micrometers), and a cross sectional height for the third flow channel of about 35 to about 65 mil (about 889 to about 1,651 micrometers).

As seen in FIG. 1, the multi-manifold coextrusion die comprises flow channels 100, 200, and 300, for directing and forming extrudates flowing through the individual flow channels into individual layers. The flow channels carrying the extrudate converge in combining region 400 of the die, wherein the flow channels are arrayed parallel to one another in the widest dimension (i.e., width) of the flow channel (not shown). Flow channel 100 enters combining region 400 at point 410, at an angle relative to flow channel 200; flow channel 300 enters combining region 400 at point 410, at an angle relative to flow channel 200; and flow channel 200 enters combining region 400 at point 410 at a point between flow channels 100 and 300. Extruded layers emerging thus from each flow channel contact the adjacent layer(s) extruded from the adjacent flow channel(s) to form a multilayer extrudate in the combining region 400. The combining region 400 narrows to form a die lip 420. The die lip 420 is adjustable in its cross-sectional height, wherein the cross-sectional height is orthogonal to the direction of flow and to the width of the die. The multilayer extrudate flows through the combining region 400 and through the die lip 420 to form a multilayer film. The die lip 420 can be adjusted to achieve the desired properties of thickness, extrusion rate, and film quality of the multilayer film so extruded.

The multilayer film, prepared by coextrusion of the polycarbonate composition, can have an overall thickness of about 1 to about 1000 mils (about 25 to about 25,400 micrometers), specifically about 5 to about 750 mils (about 125 to 19,050 micrometers), more specifically about 10 to about 200 mils (about 250 to 5,080 micrometers).

In an embodiment, polycarbonate compositions enter the flow channels at the upstream ends (for example, 110, 210, and 310 in FIG. 1), and flow through the respective flow channels at a flow rate of 1 to 200 Kg/hr, specifically 10 to 100 Kg/hr, and more specifically 20 to 90 Kg/hr. Flow rates and tolerance of the polycarbonate compositions to variations in flow can be determined for optimal performance in the formation of multilayer films by one skilled in the art. The extruded compositions exit the flow channels as discrete layers which are contacted to adjacent layer(s) in combining region 400, wherein contacted layers are substantially non-intermixing. As used herein, the term “substantially non-intermixing” means that greater than or equal to 90%, specifically greater than or equal to 95%, and more specifically greater than or equal to 99% of the thickness of each layer does not form an intermixed region with an adjacent layer. The cross-sectional height of the combining region provides thickness control for the coextruded multilayer extrudate as it is extruded from die lip 410 to form the multilayer film. The layers remain discrete and substantially non-intermixing within the multilayer film during and after extrusion from die lip 410.

It has been observed that an extruded thin multilayer film comprising polycarbonate composition having a visual effect filler can manifest parallel line defects (“streaks”) coincident with the direction of flow of the extruded multilayer film. The streaks can be randomly spaced across the width of the film (i.e. the larger dimension of the film orthogonal to the direction of extrusion, and coincident with w, above) and can be random in the intensity of appearance. Without wishing to be bound by theory, it is believed that the streaks in the extruded layer may occur at least in part when a portion of the visual effect filler is oriented in the region of the streak. As used herein, “oriented” can occur when a reflective or refractive face of a particle of the visual effect filler aligns to present the reflective or refractive face of the particle with the surface of the multilayer film. The particles so oriented in a region of the multilayer film that is parallel to the direction of extrusion thus can appear as a streak. The appearance of streaks in the extruded multilayer film may also occur when the concentration of visual effect filler in a region of the multilayer film running parallel to the direction of extrusion is higher than in an adjacent parallel region. Contrasting adjacent regions with high and low levels of visual effect filler orientation, and/or high and low filler concentrations, can thus visibly manifest as streaks. Where the visual effect filler is not oriented, it may be considered to be random. The appearance of a multilayer film can be assessed qualitatively by visual appearance of the multilayer film by comparison to a master standard having acceptable appearance. The comparison can be conducted using the naked eye under a set of lights selected for optimum viewing, wherein the optimal lighting conditions may be selected for the color and/or filler content of the multilayer film, and at a suitable distance between the viewer and the film, typically about 30 to about 150 centimeters. A determination of the presence or absence of streaks can thus be made.

Streaks in a multilayer film may also be assessed using transmission electron microscopy (TEM), wherein multiple TEM images of different regions of a multilayer film can be compared with each other to determine the variation of particle distribution and/or particle count across a multilayer film having visual effect filler therein. The pattern of distribution of visual effect filler particles appearing within the TEM image may be useful for distinguishing a streak from a non-streak, and may be useful for determining whether the filler is oriented or random, indicating the presence or absence of streaks, respectively.

It has been unexpectedly found that increasing the shear stress during coextrusion, i.e., the shear force normal to the direction of flow in the coextrusion die, for a polycarbonate composition having visual effect filler, produces a layer without streaks, specifically wherein the visual effect filler is a plate-type filler. Increasing the shear stress on the polycarbonate composition during extrusion through a flow channel, to a value in excess of a minimum value, below which streaks are observed to form, results in a layer without streaks. Shear stress can be affected by the viscosity, flow channel dimensions, flow rate, and die temperature, and therefore these parameters can be selected such that the shear stress is greater than the minimum observed value.

The polycarbonate composition having visual effect filler is thus subject to a shear stress during coextrusion, that is sufficient to provide a layer without streaks in the multilayer film. In an embodiment, a suitable shear stress experienced by the polycarbonate composition having visual effect filler in the flow channel is greater than or equal to 27 kPa. In another embodiment, a suitable shear stress experienced by the polycarbonate composition having visual effect filler in the flow channel is greater than or equal to 30 kPa. In another embodiment, a suitable shear stress experienced by the polycarbonate composition having visual effect filler in the flow channel is greater than or equal to 35 kPa. In another embodiment, a suitable shear stress experienced by the polycarbonate composition having visual effect filler in the flow channel is greater than or equal to 40 kPa. The shear stresses are determined in the flow channel prior to the convergence of the flow channels with the combining region of the multilayer coextrusion die, upstream of the combining region with respect to the direction of flow. The layer so extruded is without streaks. A multilayer film, comprising the layer without streaks, can itself be without streaks, when all other layers of the multilayer film are also without streaks.

Shear stress as determined in a flow channel during extrusion is affected by the molecular weight of the polycarbonates in the polycarbonate composition, wherein shear stress increases with increasing molecular weight. In addition, shear stress in a flow channel is affected by the viscosity of the polycarbonate composition being extruded. Suitable viscosities can be selected or adjusted to based on whether a streaking or non-streaking film is obtained. A suitable viscosity is limited by the observation that too low of a viscosity can cause the shear stress to decrease and therefore cause streaking in the film. Further, too high of a viscosity can reduce the flow in the flow channel and create an impractical throughput for manufacturing purposes.

Similarly, the melt flow rate (MVR) of a polycarbonate composition can affect whether a streaking or non-streaking film is obtained. A suitable MVR is limited by the observation that too high of an MVR can cause a decrease in the shear stress in the flow channel during extrusion, causing streaking in the film. An MVR that is too low can reduce the flow in the flow channel and create an impractically low throughput for manufacturing purposes.

A polycarbonate composition having an MVR suitable for forming a multilayer film without streaks is selected according to the cross-sectional height of the flow channels of the multimanifold die used. Thus, the combination of a polycarbonate composition having a suitable MVR, when used with a multimanifold coextrusion die having suitable flow channel dimensions, and at a suitable flow rate and extrusion temperature, provides a multilayer film without streaks. In this way, both low and high MVR polycarbonate compositions can be used with multi-manifold coextrusion dies. As used herein, for the polycarbonate composition, “low MVR” is an MVR of less than or equal to 5 cc/10 min., and “high MVR” is an MVR of greater than or equal to 5 cc/10 min., measured at 300° C. and 1.2 Kg according to ASTM D1238-04.

In an embodiment, a multilayer film without streaks can be coextruded using a multimanifold coextrusion die (as shown in FIG. 1) and using a low MVR polycarbonate composition, wherein first flow channel 100 is about 40 to about 80 mil (about 1,016 to about 2,032 micrometers) in cross-sectional height, the second flow channel 200 is about 115 to about 125 mil (about 2,921 to about 3,175 micrometers) in cross-sectional height, and the third flow channel 300 is about 55 to about 65 mil (about 1,397 to about 1,651 micrometers) in cross-sectional height. In a specific embodiment, a suitable low MVR polycarbonate composition has an MVR of about 2.5 to about 4.5 cc/10 min., measured at 300° C. and 1.2 Kg. according to ASTM D1238-04.

In another embodiment a multilayer film without streaks can be coextruded using a multimanifold coextrusion die (as shown in FIG. 1) and using a high MVR polycarbonate composition, wherein the first flow channel 100 is about 40 to about 80 mil (about 1,016 to about 2,032 micrometers) in cross-sectional height, the second flow channel 200 is about 60 to about 80 mil (about 1,524 to about 2,032 micrometers) in cross-sectional height, and the third flow channel 300 is about 35 to about 50 mil (about 889 to about 1,270 micrometers) in cross-sectional height. In a specific embodiment, a suitable high MVR polycarbonate composition has an MVR of about 7 to about 11 cc/10 min., measured at 300° C. and 1.2 Kg. according to ASTM D1238-04.

A method of extruding a multilayer film without streaks using low viscosity/high MVR polycarbonate compositions is desirable. Low viscosity/high MVR polycarbonate compositions can desirably have better melt flow at lower temperatures, and better film forming capability. However, the MVR of polycarbonate resins used to prepare polycarbonate compositions suitable for extrusion in existing dies can increase significantly upon combining with additives such as a visual effect filler and/or colorant, by an amount of as much as, for example, about 3 to about 4 cc/10 min over the MVR of the component polycarbonate resin. This can in turn impose a limit on the useful MVR for component polycarbonate resins, necessitating use of lower MVR polycarbonate resins that are more difficult to melt, flow, and extrude, and hence are less desirable to use and formulate with. However, for a coextrusion process that advantageously provides a suitable high minimum shear stress, low viscosity/high MVR polycarbonate resins can be useful, and can provide access to polycarbonate compositions with increased formulation and compositional latitude. In another advantageous feature, low viscosity/high MVR polycarbonate compositions have lower melt temperatures than high viscosity/low MVR polycarbonate compositions, and thus can desirably have higher throughput in a production line, making multilayer films prepared with them more economical to produce.

In a specific embodiment, a multilayer film without streaks is formed by coextrusion of a first layer comprising a first polycarbonate composition, with a second layer comprising a second polycarbonate composition, wherein the second polycarbonate composition comprises a polycarbonate and a visual effects filler, and wherein the second polycarbonate composition is subject to a shear stress greater than the minimum value needed to produce a multilayer film without streaks. In another embodiment, a third polycarbonate composition is coextruded with the first and second layers to form a multilayer film, where the first layer is disposed on the second layer, and the third layer is disposed on the second layer on a face opposite the first layer. As used herein, “disposed” means in at least partial contact with. The multilayer film is extruded from the multi-manifold coextrusion die, cooled, and the film can be spooled onto a roll for storage or further processing. A multilayer film so prepared is without streaks.

In another specific embodiment, a multi-manifold coextrusion die is used to form a multilayer film. The multimanifold coextrusion die has a first flow channel, a second flow channel, and a third flow channel, wherein a first polycarbonate composition comprising a weatherable composition is extruded through the first flow channel, a second polycarbonate composition is coextruded through the second flow channel, and a third polycarbonate composition is extruded through the third flow channel. At least one of the second polycarbonate composition or the third polycarbonate composition further comprises visual effect filler. The second and third polycarbonate compositions can be the same or different polycarbonate compositions. Where the second polycarbonate composition comprises visual effect filler, the shear stress in the second flow channel is sufficient to produce a multilayer film without streaks. Where the third polycarbonate composition further comprises visual effect filler, the shear stress in the third flow channel is sufficient to produce a multilayer film without streaks. In a further embodiment, an additional layer can be coextruded with the first, second, and third layers. The multilayer film is extruded from the multi-manifold coextrusion die, cooled, and the film is spooled onto a roll for storage and further processing. A multilayer film produced by this method is without streaks.

In another specific embodiment, a method of using a multi-manifold coextrusion die to extrude multilayer films without streaks comprises flowing a polycarbonate composition comprising a polycarbonate and a visual effect filler, through a multi-manifold coextrusion die comprising a first flow channel, a second flow channel, and a third flow channel, wherein the polycarbonate composition having visual effect filler flows through any one of the second flow channel, the third flow channel, or both the second and third flow channels, wherein the shear stresses obtained in each of the second and third flow channels during extrusion are each sufficient to produce a multilayer film without streaks. In a specific embodiment, different polycarbonate compositions are used in the second and third flow channels.

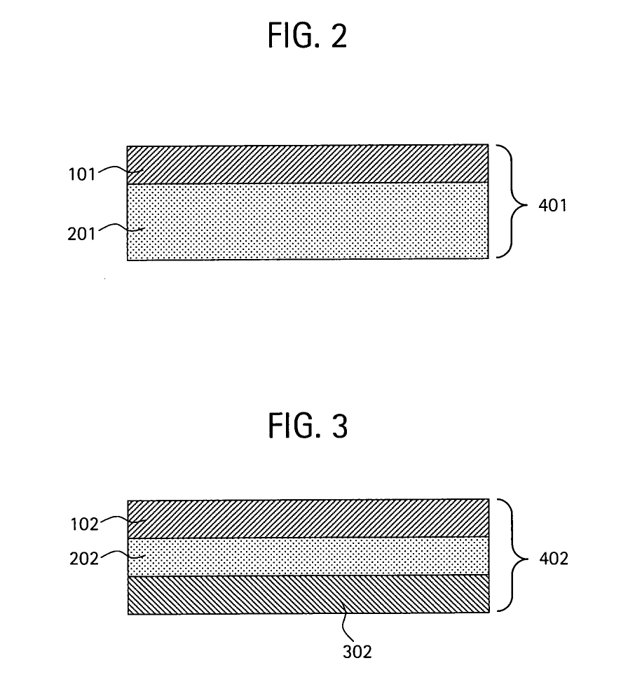

An exemplary embodiment of the multilayer film so prepared is shown in FIG. 2. FIG. 2 depicts a multilayer film 401 having a weatherable layer 101 comprising a polyester-polycarbonate composition, and a layer 201 comprising a polycarbonate composition having a visual effect filler dispersed therein. Layer 201 is without streaks. It is contemplated that there can be additional layers present, including a substrate layer, where the combination of these layers can form a completed article which can be additionally molded into a shape. A protective layer, adhesive layer, or both can be adhered to either or both faces of the multilayer film to protect the film during processing and to provide an adhesive surface for bonding the multilayer film to a substrate. The application of the additional layers can be by extrusion (including coextrusion), lamination, calendaring, rolling, or other suitable methods.

Another exemplary embodiment of the multilayer film so prepared is shown in FIG. 3. FIG. 3 depicts a multilayer film 402 having a weatherable layer 102 comprising a polyester-polycarbonate composition, a layer 202 comprising a polycarbonate composition, and a layer 302 comprising a polycarbonate composition. At least one of the polycarbonate compositions of layer 202 and of layer 302 comprises visual effect filler, and layers 202 and 302 can be the same or different. It is contemplated that there can be additional layers present, where desired. For example, an additional layer comprising the polycarbonate composition or other suitable compositions may be present. In an embodiment, an adhesive layer can optionally be applied to the exposed face of layer 302, to provide a surface for bonding to a substrate. A protective layer can be contacted to the polycarbonate layer opposite the adhesion layer, to the adhesion layer, or to both.

The multilayer film can be contacted to the surface of a substrate material by laminating, calendaring, rolling, or other suitable methods of application. The multilayer film can be adhered to the surface of the substrate in this process, wherein the surface of the multilayer film opposite the layer of weatherable polycarbonate composition is contacted to the substrate. The multilayer film can be adhered directly to the substrate, or can be adhered through an intermediate layer comprising an adhesive composition. The resulting surface finished sheet can be molded to form an article using a suitable molding method, such as, for example, thick sheet forming (TSF). Other suitable contacting methods include thermoforming followed by in-mold decorating (IMD) wherein the multilayer film is thermoformed to a shape, placed in a mold, and back-molded with the substrate.

Articles which can be made which comprise the multilayer films provided by the above method include articles for: exterior and interior components for aircraft, automotive, truck, military vehicle (including automotive, aircraft, and water-borne vehicles), scooter, and motorcycle, including panels, quarter panels, rocker panels, vertical panels, horizontal panels, trim, fenders, doors, decklids, trunklids, hoods, bonnets, roofs, bumpers, fascia, grilles, mirror housings, pillar appliques, cladding, body side moldings, wheel covers, hubcaps, door handles, spoilers, window frames, headlamp bezels, headlamps, tail lamps, tail lamp housings, tail lamp bezels, license plate enclosures, roof racks, and running boards; enclosures, housings, panels, and parts for outdoor vehicles and devices; enclosures for electrical and telecommunication devices; outdoor furniture; aircraft components; boats and marine equipment, including trim, enclosures, and housings; outboard motor housings; depth finder housings, personal water-craft; jet-skis; pools; spas; hot-tubs; steps; step coverings; building and construction applications such as glazing, roofs, windows, floors, decorative window furnishings or treatments; treated glass covers for pictures, paintings, posters, and like display items; wall panels, and doors; counter tops; protected graphics; outdoor and indoor signs; enclosures, housings, panels, and parts for automatic teller machines (ATM); enclosures, housings, panels, and parts for lawn and garden tractors, lawn mowers, and tools, including lawn and garden tools; window and door trim; sports equipment and toys; enclosures, housings, panels, and parts for snowmobiles; recreational vehicle panels and components; playground equipment; shoe laces; articles made from plastic-wood combinations; golf course markers; utility pit covers; computer housings; desk-top computer housings; portable computer housings; lap-top computer housings; palm-held computer housings; monitor housings; printer housings; keyboards; FAX machine housings; copier housings; telephone housings; phone bezels; mobile phone housings; radio sender housings; radio receiver housings; light fixtures; lighting appliances; network interface device housings; transformer housings; air conditioner housings; cladding or seating for public transportation; cladding or seating for trains, subways, or buses; meter housings; antenna housings; cladding for satellite dishes; coated helmets and personal protective equipment; coated synthetic or natural textiles; coated photographic film and photographic prints; coated painted articles; coated dyed articles; coated fluorescent articles; coated foam articles; and like applications. The invention further contemplates additional fabrication operations on the articles, such as, but not limited to, molding, in-mold decoration, baking in a paint oven, lamination, and/or thermoforming.

The above properties are further illustrated by the following non-limiting examples.

Examples and comparative examples of multilayer films were prepared by coextrusion of polycarbonate formulations using either a single manifold coextrusion die or a 3-channel multi-manifold coextrusion die. The multilayer films prepared using the single manifold coextrusion die were each prepared with a top layer of a weatherable composition free of added color and fillers. The multilayer films prepared using the multi-manifold coextrusion die were prepared having three coextruded layers, comprising a top layer having weatherable characteristics, and middle and bottom layers each comprising a polycarbonate composition.

A weatherable composition used to form the top layer was prepared using a poly(isophthalate-terephthalate-resorcinol)-bisphenol-A polycarbonate copolymer (also referred to as “ITR-PC”), having a Mw of about 20,000 or 24,500 as determined using gel permeation chromatography (GPC) using a cosslinked styrene-divinyl benzene column, a sample concentration of about 1 mg/ml, and polycarbonate standards. Unless otherwise noted, GPC values disclosed herein are each determined according to the above method. The polycarbonate composition used to prepare the middle layer was prepared using bisphenol-A polycarbonate (also referred to as “BPA-PC”) having a Mw of 30,000 or 35,000 as determined using GPC. The polycarbonate compositions used to prepare the bottom layer for multilayer films prepared using the multi-manifold coextrusion die were prepared using BPA-PC (Mw of about 35,000 as determined using GPC and the above conditions), or a combination comprising 75 parts by weight BPA-PC and 25 parts by weight of bisphenol-A polycarbonate-poly(phthalate-carbonate) (also referred to as “PC-PPC”) having a Mw of about 28,000 to 40,000 g/ mol. as determined using GPC and the above conditions. The polycarbonate compositions used in the bottom and/or middle layers were either colored using a colorant or visual effect filler without colorant. For the colored compositions, a combination of colorants and/or pigments was formulated to provide a green color, referred to as “onyx green”. Visual effect filler for the green polycarbonate composition was a platelet-type mica filler having approximate mean particle sizes of both 25 and 50 micrometers. Silver formulations used flake-type fillers comprising treated or untreated aluminum flakes having a mean particle size of 15 micrometers (treated) and 18 micrometers (untreated) flakes. Also present in the polycarbonate compositions are thermal stabilizers. Materials used for forming the multilayer film examples and comparative examples are listed in Table 1.

TABLE 1^{†}

| Material | Description | Source |
|---|---|---|
| ITR-PC | Isophthalate-Terephthalate-Resorcinol Polyester- | GE Plastics |
| | Bisphenol-A Polycarbonate; | |
| | 25 mole percent ester content; Mw = 20K, 24.5K, 35K | |
| BPA-PC | Bisphenol-A Polycarbonate; Mw = 30K or 35K | GE Plastics |
| PC-PPC | Isophthalate-Terephthalate-Bisphenol-A Polyester- | GE Plastics |
| | Bisphenol-A Polycarbonate Copolymer; | |
| | 80 mole-% ester content; Mw = 28-40K | |
| Pigment | Pigment combination, in parts by weight (pbw): | — |
| | 19.38 pbw Pigment Black 7 | |
| | 19.80 pbw Pigment Blue 60 | |
| | 4.24 pbw Disperse Violet 13 | |
| | 56.58 pbw Solvent Blue 101 | |
| Mica-A | Afflair ® 9507 Scarab Mica Pigment, 25 μm appx. mean | EM Industries |
| | particle diameter | |
| Mica-B | Afflair ® 153 Pearl Mica Pigment, 50 μm appx. mean | EM Industries |
| | particle diameter | |
| Al Flake | Variochrom ® K1000, silicone coated aluminum flake; 15 | BASF |
| A | μm appx. mean particle diameter | |
| Al Flake | Silberline ® 950-20-C, 18 μm appx. mean particle | BASF |
| B | diameter | |
| Stabilizer | Weston ™ DPDP | Crompton |
| 1 | | Corp. |
| Stabilizer | Sandostab ™ P-EPQ | Clariant Corp. |
| 2 | | |
| Stabilizer | Doverphos ™ S9228 | Dover |
| 3 | | Chemical Co. |

^{†}Molecular weight Mw is reported in Table 1 in thousands of AMU (K).

The polycarbonate compositions used for each of the top, middle, and bottom layers of the multilayer films are shown in Table 2, below. The polycarbonate compositions are identified by a letter from A-K, and the formulation for each individual polycarbonate composition is provided as the relative amount of each component in parts by weight relative to 100 parts of the polycarbonate polymer in the composition.

TABLE 2*

| Material | A | B | C | D | E | F | G | H | I | J | K |
|---|---|---|---|---|---|---|---|---|---|---|---|
| ITR-PC (Mw | 100 | — | — | — | — | — | — | — | — | — | — |
| 20K) | | | | | | | | | | | |
| ITR-PC (Mw | — | 100 | — | 100 | — | — | — | — | — | — | — |
| 24.5K) | | | | | | | | | | | |
| ITR-PC (Mw | — | — | 100 | — | — | — | — | — | — | — | — |
| 35K) | | | | | | | | | | | |
| BPA-PC | — | — | — | — | 100 | — | — | 75 | — | — | 100 |
| (Mw 30K) | | | | | | | | | | | |
| BPA-PC | — | — | — | — | — | 100 | 100 | — | 75 | 100 | — |
| (Mw 35K) | | | | | | | | | | | |
| PC-PPC | — | — | — | — | — | — | — | 25 | 25 | — | — |
| Pigment | — | — | — | <0.01 | 0.07 | 0.07 | 0.07 | — | — | — | — |
| | | | | (trace) | | | | | | | |
| Mica A | — | — | — | — | 0.75 | 0.75 | 0.75 | — | — | — | — |
| Mica B | — | — | — | — | 1.65 | 1.65 | 1.65 | — | — | — | — |
| Al Flake A | — | — | — | — | — | — | — | 1.0 | 1.0 | — | — |
| Al Flake B | — | — | — | — | — | — | — | — | — | 3.0 | 3.0 |
| Stabilizer 1 | — | — | — | — | 0.05 | 0.05 | 0.05 | — | — | — | — |
| Stabilizer 2 | — | — | — | — | — | — | — | 0.06 | 0.06 | 0.06 | 0.06 |
| Stabilizer 3 | 0.03 | 0.03 | 0.03 | 0.03 | | | | | | | |
| Total | 100.03 | 100.03 | 100.03 | 100.03 | 102.52 | 102.52 | 102.52 | 101.06 | 101.06 | 103.06 | 103.06 |

*Note:
amounts are given in parts by weight (pbw), relative to 100 pbw of polycarbonate composition

Physical properties of the polycarbonate compositions are described in Table 3, below. Viscosities are determined at a shear rate of 0.1 sec⁻¹ and at a temperature of 530° F. (277° C.), using a parallel plate rheometer, according to ASTM D4440-01. Melt flow rates (MVR) were determined according to the method in ASTM D1238-04.

TABLE 3

| | | | Viscosity at | MVR (cc/10 | Visual |
|---|---|---|---|---|---|
| | Material | PC Mw | 0.1 sec⁻¹, | min at 300° C. | Effects |
| Material | color | (AMU) | 277° C. (P) | 1.2 Kg) | filler? (Y/N) |
| A | Clear | 20,000 | 13,100 | 8-10 | N |
| B | Clear | 24,500 | 23,000 | 3-4 | N |
| C | Clear | 24,500 | 14,000 | 3-4 | N |
| D | Clear | 24,500 | 25,500 | 3-4 | N |
| E | Green | 30,000 | 14,000 | 8-10 | Y |
| F | Green | 35,000 | 24,000 | 3-4 | Y |
| G | Green | 35,000 | 39,000 | 3-4 | Y |
| H | Silver | 30,000 | 14,400 | 8-10 | Y |
| I | Silver | 35,000 | 35,000 | 3-4 | Y |
| J | Silver | 30,000 | 9,200 | 8-10 | Y |
| K | Silver | 35,000 | 20,600 | 3-4 | Y |

Polycarbonate compositions A through K were prepared with a range of viscosities for use in the preparation of examples and comparative examples. Examples of multilayer films were prepared using coextrusion methods below.

The multilayer films in the examples were prepared by coextrusion using either: a coextrusion line having a single manifold coextrusion die (“coathanger” design) having a die lip opening of 40 mils (1,000 micrometers), with a main extruder (color layer) having a 3.5 inch (8.9 cm) screw operating at a feed rate of 36 to 54 Kg/hour, and an outboard extruder (weatherable layer) having a 2.5 inch (6.35 cm) screw operating at a feed rate of 118 to 164 Kg/hour, wherein both extruders feed into a single channel feedblock which in turn feeds into the single manifold of the die; or a coextrusion line having a multi-manifold coextrusion die with the configuration shown in FIG. 2, a lip aperture opening of 40 mils (1,000 micrometers), with an outboard extruder having a 2 inch (5.1 cm) screw operating at a feed rate of 30 Kg/hour feeding into flow channel 100, a main extruder having a 2 inch (5.1 cm) screw operating at a feed rate of 90 Kg/hour feeding into flow channel 200, and an outboard extruder having a 2 inches (5.1 cm) operating at a feed rate of 30 Kg/hour feeding into flow channel 300. The cross-sectional heights for flow channels 100, 200, and 300 (see FIG. 2) in the multi-manifold coextrusion die are as shown in Table 4, below. Also provided is the extruder throughput (flow rate) for each flow channel and corresponding layer in the extrusion process.

TABLE 4

| Flow Channel | | | Multi- |
|---|---|---|---|
| location for Multi- | | | manifold |
| manifold | | Multi-manifold Flow | Extruder |
| Coextrusion Die | Polymer in | Channel Dimensions | Throughput |
| (see FIG. 1) | Composition | (Control) | (Kg/hr) |
| 100 (top) | ITR-PC | 75 mil (1905 micrometers) | 30 |
| 200 (middle) | BPA-PC; or BPA- | 120 mil (3048 micrometers) | 90 |
| | PC/PC-PPC | | |
| 300 (bottom) | BPA-PC; or BPA- | 60 mil (1524 micrometers) | 30 |
| | PC/PC-PPC | | |

Typical temperature profiles for the extruders and coextrusion dies, corresponding to the specific type of polycarbonate polymer used in the polycarbonate composition extruded, are given in Table 5.

TABLE 5

| Polymer in | Extruder | |
|---|---|---|
| Extruded | Temperature | Die Temperature |
| Composition | Profile | Profile |
| BPA-PC or BPA- | 400-500° F. | 490-550° F. |
| PC/PC-PPC | (204-260° C.) | (254-288° C.) |
| ITR-PC | 440° F.-500° F. | 490-550° F. |
| | (227-260° C.) | (254-288° C.) |

### EXAMPLE 1

A two layer film was extruded using a single manifold coextrusion die, wherein the bottom layer feed is done using the main extruder, and the top layer feed uses the outboard extruder, using the temperature profile described in Table 5. The polycarbonate compositions used are shown in Table 6, below. Shear stress, in kilo-Pascals, was maintained in the range of 120 to 170 kPa at the lip of the single manifold extruder die using the feed rates described above. The multilayer film was extruded to a total thickness of 30 mils (750 micrometers), with a top layer (clear) thickness of 10 mil (250 micrometers), and a bottom layer thickness of 20 mil (500 micrometers). The multilayer film produced was visually inspected for streaks, with a determination of the presence of streaks based on qualitative manufacturing standards. The data for Example 1 is shown in Table 6.

TABLE 6

| | | | | | |
|---|---|---|---|---|---|
| | | Top layer | Bottom | | |
| | | film | layer film | Shear | |
| | Film tks* in | (outboard | (main | stress | |
| Example | mils (μm) | extruder) | extruder) | (kPa) | Streaks |

| | | | | | |
|---|---|---|---|---|---|
| Ex. 1 | 30 (750) | C | G | 120-170 | No |

*thickness

As seen in the data in Table 6, a multilayer film without streaks can be produced using a single manifold multilayer coextrusion die operating at a high shear stress of greater than or equal to 40 kPa. A typical shear stress for a multilayer film extruded using a single manifold multilayer coextrusion die is about 44 kPa for formulation E and about 70 kPa for formulation F. A film without streaks can be prepared using either of these compositions.

### EXAMPLES 2 and 3, and COMPARATIVE EXAMPLES 1-7

Examples 2 and 3, and Comparative Examples 1 through 7 were either actual or calculated runs, as specified in Table 8, below. The calculated runs were used to determine the effect on shear stresses in layers of the multilayer films wherein viscosity data for a polycarbonate composition with an experimentally determined shear viscosity/MVR is substituted for a polycarbonate composition actually used to generate an example or comparative example using the multi-manifold coextrusion die described above. Shear stresses were determined in the multi-manifold die (shown in FIG. 1) at flow channel 100 for the top layer (TL), 200 for the middle layer (ML), and 300 for the bottom layer (BL). The shear stress was determined for a point 0.25 inches (6.4 millimeters) upstream with respect to the direction of flow of the extrudate, from the combining region of the multi-manifold die. Film thickness is 50 mil (1,250 micrometers). A 50 mil green film comprises a 10 mil (250 μm) top layer, a 20 mil (500 μm) middle layer, and a 20 mil (500 μm) bottom layer. A 50 mil silver film comprises a 10 mil (250 μm) top layer, a 10 mil (250 μm) middle layer, and a 30 mil (750 μm) bottom layer. For actual Examples 2, 3, and 7, and Comparative Examples 2 and 4, the multilayer film produced was visually inspected for streaks, with a determination of the presence of streaks based on qualitative manufacturing standards.

TABLE 8

| | | Top | | | | | | | |
|---|---|---|---|---|---|---|---|---|---|
| | | layer | TL | Mid | ML | Bottom | BL | Example | |
| | | Form. | Shear | layer | Shear | layer | Shear | Type | |
| Example | Film | (TL; | Stress | Form. | Stress | Form. | Stress | (actual or | Streaks |
| no. | Color | Clear) | (kPa) | (ML) | (kPa) | (BL) | (kPa) | simulation) | (Y/N) |
| Comp. | Green | C | 36.4 | E | 15.6 | E | 20.5 | Simulation | — |
| Ex. 1 | | | | | | | | | |
| Comp. | Green | B | 26.9 | E | 15.6 | E | 20.5 | Actual | Y |
| Ex. 2 | | | | | | | | | |
| Comp. | Green | C | 36.4 | F | 27.3 | F | 35.7 | Simulation | — |
| Ex. 3 | | | | | | | | | |
| Comp. | Green | C | 36.4 | F | 26.9 | F | 35.7 | Actual | Y |
| Ex. 4 | | | | | | | | | |
| Ex. 2 | Green | C | 36.4 | G | 43.1 | G | 56.2 | Actual | N |
| Comp. | Green | A | 14.6 | G | 43.1 | G | 56.1 | Simulation | — |
| Ex. 5 | | | | | | | | | |
| Ex. 3 | Silver | D | 25.8 | I | 40.1 | K | 31.2 | Actual | N |
| Comp. | Silver | A | 14.6 | I | 40.0 | K | 31.2 | Simulation | — |
| Ex. 6 | | | | | | | | | |
| Comp. | Silver | D | 25.8 | H | 17.8 | J | 16.3 | Actual | Y |
| Ex. 7 | | | | | | | | | |

From the above data, it can be seen that a multilayer film without streaks is obtained in Examples 2 and 3 at a shear stress during extrusion of 40.1 and 43.1 kPa (respectively) for the middle layer as extruded from the center flow channel (FIG. 1, flow channel 200) of the multi-manifold coextrusion die. Comparative Example 4, with a shear stress of 26.9 kPa, exhibited streaks in the multilayer film. From these data, it can be seen that a multilayer film without streaks can be obtained using a shear stress above this value, and a multilayer film without streaks is clearly obtainable using a shear stress of 40.1 kPa. Further, as seen in the simulated data, decreasing the shear stress of an adjacent layer, as simulated in flow channel 100 and as shown in Comparative Examples 5 and 6, show a minimal effect on the shear stress in the center flow channel 200.

Multi-manifold Coextrusion Die Design using Flow Simulation.

Flow simulations were run using the Flow2OOO flow simulation software package developed by Compuplast Canada, Inc. Viscosity curves (viscosity versus shear rate) were plotted for polycarbonate compositions B (top layer) and E (middle and bottom layers), each with melt-volume flow indices (MVR) of 8-10 cc/10 min., and polycarbonate composition G with an MVR of 3 cc/10 min. (where all MVR values are determined at 300° C. and 1.2 Kg, according to ASTM D1238-04) at temperatures of 500° F, 530° F., and 560° F. (260, 277, and 293° C. respectively), for use in calculating flow channel cross-sectional height for the design of a multi-manifold die. In the new design determined by the simulations, cross-sectional height for flow channels 100 (top layer), 200 (middle layer) and 300 (bottom layer), as shown in FIG. 1, were each calculated to provide minimum shear stress values of about 30 kPa, using the measured viscosities for the above polycarbonate compositions. Table 9 is a summary table for the polycarbonate compositions for which the viscosities were used in the calculation of the new flow channel cross-sectional heights.

TABLE 9

| Multilayer | Polycarbonate | | | |
|---|---|---|---|---|
| film Color | composition | Layer | MVR | Streaks* |
| Green | C | Top | 3-4 | N/A |
| | E | Middle/Bottom | 8-10 | Streak |
| | G | Middle/Bottom | 3-4 | No Streak |
| Silver | D | Top | 3-4 | N/A |
| | H | Middle | 8-10 | Streak |
| | I | Middle | 3-4 | No Streak |
| | J | Bottom | 8-10 | Streak |
| | K | Bottom | 3-4 | No Streak |

*Based on model.

The shear stresses and cross-sectional heights of the flow channels for both the existing (control) and calculated (modified) multi-manifold coextrusion dies are provided for the coextrusion of the green multilayer film in Table 10, below.

TABLE 10

| Flow | | | | | |
|---|---|---|---|---|---|
| Channel | | | | | |
| Multi- | Multi- | Shear | Shear | Multi- | Shear Stress |
| manifold | manifold Die | Stress | Stress | manifold Die | (kPa), PC |
| Die | Dimensions | (kPa), PC | (kPa), PC | Dimensions | Comp. E, for |
| (FIG. 1) | (Control) | Comp. E | Comp. G | (Modified) | Modified Die |
| 100 (top- | 75 mil (1,905 | 14 | 36 | 47 mil (1,194 | 36 |
| clear) | micrometers) | | | micrometers) | |
| 200 | 120 mil (3,048 | 15 | 43 | 70 mil (1,778 | 37 |
| (middle) | micrometers) | | | micrometers) | |
| 300 | 60 mil (1,524 | 20 | 56 | 43 mil (1,092 | 37 |
| (bottom) | micrometers) | | | micrometers) | |

The shear stresses and cross-sectional heights of the flow channels for both the existing (control) and calculated multi-manifold coextrusion dies are provided for the coextrusion of a silver multilayer film in Table 11, below.

TABLE 11

| Flow | | Shear | Shear | | |
|---|---|---|---|---|---|
| Channel | | Stress | Stress | | Shear Stress |
| Multi- | Multi- | (kPa), PC | (kPa), PC | Multi- | (kPa), PC |
| manifold | manifold Die | Comp. J | Comp. K | manifold Die | Comp. J (ML) |
| Die | Dimensions | (ML) and | (ML) and I | Dimensions | and H (BL), for |
| (FIG. 1) | (Control) | H (BL) | (BL) | (Modified) | Modified Die |
| 100 (top- | 75 mil | 26 | 26 | 47 mil | 36 |
| clear) | (1,905 | | | (1,194 | |
| | micrometers) | | | micrometers) | |
| 200 | 120 mil | 18 | 40 | 70 mil | 48.7 |
| (middle) | (3,048 | | | (1,778 | |
| | micrometers) | | | micrometers) | |
| 300 | 60 mil | 16 | 31 | 43 mil | 30.3 |
| (bottom) | (1,524 | | | (1,092 | |
| | micrometers) | | | micrometers) | |

The above data shows that, by decreasing the cross-sectional height of flow channel 100 to 47 mils (1,194 micrometers), flow channel 200 to 70 mils (1,778 micrometers), and flow channel 300 to 43 mils (1,092 micrometers), the calculated shear stress in each flow channel is greater than a minimum value of about 30 kPa for the polycarbonate compositions evaluated. The calculated shear stress in flow channel 200 is 37 kPa for polycarbonate composition E (green), and 48.7 kPa for polycarbonate composition J (silver). Each of polycarbonate compositions E and J as modeled above, would therefore be extruded at a shear stress greater than or equal to the minimum value expected to provide a layer without streaks. Thus, use of a multi-manifold coextrusion die with the above flow channel cross-sectional heights is expected to provide a shear stress in flow channel 200 that is suitable for producing a multilayer film without streaks, when used to extrude a higher flow polycarbonate composition having plate-type filler and an MVR of about 8 to about 10 cc/10 min at 1.2 Kg and 300° C. according to ASTM D1238-04. Flow channel 100, used to provide the weatherable (top) layer of the multilayer film, provides adequate flow using MVR properties of weatherable polyester-polycarbonate compositions characteristic of typical production lots. Thus, a redesigned flow channel dimension for flow channel 100 is not necessary, and therefore the dimension of this flow channel can be maintained at 75 mil (1,905 micrometers).

The shear stress modeling of the higher-flow polycarbonate composition for the improved multimanifold die design was calculated for extrusion at 530° F. (277° C.). Temperature tolerance modeling using the above software package and the polycarbonate composition J (silver) shows that the shear stress can optimally be maintained above 40 kPa in flow channel 200 where the extrusion temperature is maintained at 530° F.±5° F. (277° C.±2.8° C.).

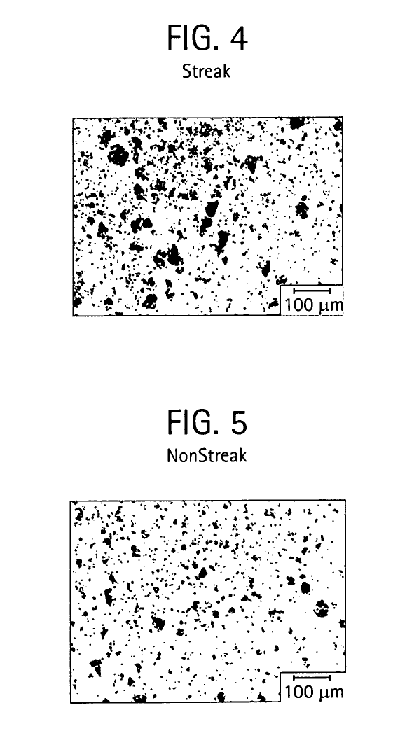

Transmission Electron Microscopy (TEM) images for Comparative Example 4 (prepared using polycarbonate composition F), of a region of the extruded green multilayer film of 50 mil (1,250 micrometers) thickness having streaks (FIG. 4) and a region having a normal appearance (FIG. 5) was also performed, and a comparison of the data is shown in Table 12, below. Samples for TEM observation were prepared by cutting, blocking and facing of samples on a Leica UCT ultramicrotome. Final microtomy of 100 nm sections was performed at room temperature on the Leica UCT. The sections were stained with RuO₄ solution for 2 minutes. The samples were viewed at 66,000 X magnification.

The extrusion conditions, specifically the shear stress imposed on the polycarbonate composition during extrusion, significantly affects the optical properties of the resulting multilayer film. FIG. 4 displays a TEM image of a parallel line defect (i.e., a streak) in a sample of the multilayer film from Comparative Example 4, which comprises 2.4 parts by weight total mica flake filler per 100 parts BPA-PC. FIG. 5 displays a TEM image of a region outside of a parallel line defect in a sample of the multilayer film from Comparative Example 4. The TEM micrograph displayed in FIG. 4 (streak) shows a significant concentration of mica flake filler (dark regions dispersed in the lighter colored polycarbonate composition matrix), wherein the mica is visually non-uniformly distributed throughout the field of the image. By contrast, the TEM micrograph in FIG. 5 (the non-streak region of the same film) shows both a significantly lower concentration of and visually more uniform distribution of the mica flake filler. Since both TEM images were obtained from a single sample of film, the difference in concentration of visual effect filler in FIGS. 4 and 5 clearly show that the visual effect filler in a multilayer film having streaks is unevenly dispersed throughout the entire sample.

The particles can be counted and statistically evaluated using software provided with the TEM microscope. Table 13 shows particle count data for each of FIGS. 4 and 5.

TABLE 13

| Property | (streak) | (non-streak) |
|---|---|---|
| Min. Particle Size (Area, in μm²) | 1.1 | 1.1 |
| Max. Particle Size (Area, in μm²) | 3,276.4 | 946.2 |
| Mean Particle Size (Area, in μm²) | 59.4 | 36.1 |
| Field area (μm²) | 457,543 | 457,543 |
| Total Particles in Field area | 80,906 | 41,464 |
| Total Particles per square millimeter (mm²) | 189,320 | 97,026 |

As seen in the above data, the streak region of the multilayer film (FIG. 4) has a total number of counted particles per square millimeter (mm²) of 189,320, whereas the non-streak region (FIG. 5) has a total number of counted particles of 97,026 per mm². The ratio of observed particles in the streak region to non-streak region is 1.95:1, and thus the streak region contains 95% excess of particles. In addition, the mean particle size is greater in the streak region (59.4 μm²) than in the non-streak region (36.1 μm²). By quantifying and/or qualifying particles in TEM images obtained from different, random regions of a multilayer film, a streak may be defined over a non-streak using the variation in measurement, and thus a method of qualifying streaks based on the relative ratio of observable particles is provided. In addition, use of a TEM micrograph as a qualitative or quantitative tool for assessing the uniformity of distribution of particles within a multilayer film, by visual inspection of the TEM, can be done.

The use of the terms “a” and “an” and “the” and similar referents in the context of this disclosure (especially in the context of the following claims) are to be construed to cover both the singular and the plural, unless otherwise indicated herein or clearly contradicted by context. Further, it should be noted that the terms “first,” “second,” and the like herein do not denote any order, quantity, or importance, but rather are used to distinguish one element from another. Likewise, it is noted that the terms “bottom”, “middle”, and “top” are used herein, unless otherwise noted, merely for convenience of description, and are not limited to any one position or spatial orientation. The modifier “about” used in connection with a quantity is inclusive of the stated value and has the meaning dictated by the context (e.g., includes the degree of error associated with the measurement of the particular quantity).

Compounds are described using standard nomenclature. For example, any position not substituted by any indicated group is understood to have its valency filled by a bond as indicated, or a hydrogen atom. A dash that is not between two letters of symbols is used to indicate a point of attachment for a substituent. For example, -CHO is attached through carbon of the carbonyl group.

All ranges disclosed herein are inclusive and combinable (e.g., ranges of “up to about 25 wt %, with about 5 wt % to about 20 wt % desired,” is inclusive of the endpoints and all intermediate values of the ranges of “about 5 wt % to about 25 wt %,” etc.). The notation “±5° F.” means that the indicated measurement can be from an amount that is minus 5° F. to an amount that is plus 5° F. of the stated value.

While the invention has been described with reference to a preferred embodiment, it will be understood by those skilled in the art that various changes can be made and equivalents can be substituted for elements thereof without departing from the scope of the invention. In addition, many modifications can be made to adapt a particular situation or material to the teachings of the invention without departing from essential scope thereof. Therefore, it is intended that the invention not be limited to the particular embodiment disclosed as the best mode contemplated for carrying out this invention, but that the invention will include all embodiments falling within the scope of the appended claims.

We claim:

1. A method of forming a multilayer film, comprising coextruding
a first layer comprising a first polycarbonate composition, with
a second layer comprising a second polycarbonate composition comprising
a polycarbonate, and
a visual effect filler,
wherein the second polycarbonate composition is subject to a shear stress of greater than or equal to 40 kilo-Pascals during the coextruding.

2. The method of claim I wherein the second polycarbonate comprises polycarbonate, isophthalate-terephthalate-bisphenol-A polyester-bisphenol-A polycarbonate, or a combination comprising at least one of the foregoing polycarbonates.

3. The method of claim 1 wherein the visual effect filler is a plate-type filler having a mean diameter of about 10 to about 60 micrometers.

4. The method of claim 3, wherein the visual effect filler comprises aluminum, mica, or a combination comprising at least one of the foregoing visual effects fillers.

5. The method of claim 1, wherein the second polycarbonate composition further comprises a colorant.

6. The method of claim 1, wherein the first layer is disposed on the second layer during the coextruding.

7. The method of claim 1, further comprising a third layer comprising a third polycarbonate composition comprising a polycarbonate, wherein the third layer is coextruded with the first and second layers, and wherein the third layer is either disposed during coextrusion on a side of the second layer opposite the first layer, or disposed during coextrusion between the second layer and the first layer.

8. The method of claim 7, wherein the third polycarbonate composition comprises a visual effect filler, and wherein the third polycarbonate composition is subject to a shear stress of greater than or equal to 40 kilo-Pascals during extrusion of the third layer.

9. The method of claim 7, further comprising an additional layer coextruded with the first, second, and third layers.

10. The method of claim 1 wherein the first polycarbonate composition comprises a polyester-polycarbonate.

11. The method of claim 1, wherein the multilayer film as prepared by the method is without streaks, as determined using transmission electron microscopy.

12. A method of forming a multilayer film, comprising coextruding
a first layer comprising a first polycarbonate composition,
a second layer comprising a second polycarbonate composition, and
a third layer comprising a third polycarbonate composition,
through a multi-manifold coextrusion die, wherein the multi-manifold coextrusion die comprises a first flow channel, a second flow channel, and a third flow channel, wherein each of the flow channels converge in a combining region of the multi-manifold coextrusion die;
wherein the first polycarbonate composition flows through the first flow channel to form the first layer, the second polycarbonate composition flows through the second flow channel to form the second layer, and the third polycarbonate composition flows through the third flow channel to form the third layer; wherein the second layer is disposed on the first layer, and the third layer is disposed on a side of the second layer opposite the first layer;
wherein the second polycarbonate composition, the third polycarbonate composition, or both the second polycarbonate composition and the third polycarbonate composition comprises a visual effect filler; and
wherein the polycarbonate composition comprising the visual effect filler is subject to a shear stress during extrusion through the flow channel of greater than or equal to 40 kilo-Pascals, prior to the convergence of the flow channels in the combining region.

13. The method of claim 12, wherein the first flow channel has a cross sectional height orthogonal to the direction of flow of about 70 to about 80 mil (about 1,778 to about 2,032 micrometers), the second flow channel has a cross sectional height orthogonal to the direction of flow of about 115 to about 125 mil (about 2,921 to about 3,175 micrometers), and the third flow channel has a cross sectional height orthogonal to the direction of flow of about 55 to about 65 mil (about 1,397 to about 1,651 micrometers).

14. The method of claim 13, wherein the polycarbonate composition comprising the visual effect filler has a melt volume rate (MVR) of about 2.5 to about 4.5 cubic centimeters per 10 minutes as determined at 1.2 kilograms and 300° C. according to ASTM D1238-04.

15. The method of claim 12, wherein the first flow channel has a cross sectional height orthogonal to the direction of flow of about 40 to about 80 mil (about 1,016 to about 2,032 micrometers), the second flow channel has a cross sectional height orthogonal to the direction of flow of about 60 to about 80 mil (about 1,524 to about 2,032 micrometers), and the third flow channel has a cross sectional height orthogonal to the direction of flow of about 35 to about 50 mil (about 889 to about 1,270 micrometers).

16. The method of claim 15, wherein the polycarbonate composition comprising visual effect filler has a melt volume rate (MVR) of about 7 to about 11 cubic centimeters per 10 minutes as determined at 1.2 kilograms and 300° C. according to ASTM D1238-04.

17. The method of claim 12, wherein the first polycarbonate composition comprises a polyester-polycarbonate.

18. The method of claim 12, wherein the multilayer film is without streaks.

19. A method of using a multi-manifold coextrusion die to extrude a multilayer film, comprising flowing
a polycarbonate composition comprising
a polycarbonate, and
a visual effect filler,
wherein the polycarbonate composition has a melt flow rate (MVR) of about 7 to about 11 cubic centimeters per 10 minutes as determined at 1.2 kilograms and 300° C. according to ASTM D1238-04; through
a multi-manifold coextrusion die, comprising a first flow channel having a cross sectional height orthogonal to the direction of flow of about 40 to about 80 mil (about 1,016 to about 2,032 micrometers), a second flow channel having a cross sectional height orthogonal to the direction of flow of about 60 to about 80 mil (about 1,524 to about 2,032 micrometers), and a third flow channel having a cross sectional height orthogonal to the direction of flow of about 35 to about 50 mil (about 889 to about 1,270 micrometers);
wherein the polycarbonate composition flows through the second flow channel, the third flow channel, or both the second and third flow channels, and wherein the polycarbonate composition is subject to a shear stress during extrusion of greater than or equal to 40 kilo-Pascals, prior to the convergence of the flow channels in the combining region.

20. The method of claim 19, wherein the multilayer film is without streaks.
